(19) United States
(12) Patent Application Publication
(10) Pub. No.: US 2019/0112528 A1
(43) Pub. Date: Apr. 18, 2019

(54) SOIL ENHANCEMENT MATERIALS AND METHODS

(71) Applicant: HELIAE DEVELOPMENT LLC, Gilbert, AZ (US)

(72) Inventors: Suting Huang, Gilbert, AZ (US); Laura Carney, Chandler, AZ (US); Braden Bennett, Gilbert, AZ (US); Michael Miller, Chandler, AZ (US); Grace Stearman, Gilbert, AZ (US)

(21) Appl. No.: 16/012,657

(22) Filed: Jun. 19, 2018

Related U.S. Application Data
(60) Provisional application No. 62/572,363, filed on Oct. 13, 2017.
(60) Provisional application No. 62/584,311, filed on Nov. 10, 2017.

(51) Int. Cl. C09K 17/48; A01C 21/00; A01C 23/02; A01C 23/04

(52) U.S. Cl. CPC C09K 17/48; A01C 21/00; A01C 21/007; A01C 23/047; A01C 23/042; A01C 23/023

(57) ABSTRACT

Biomass compositions and methods for improving health of soil by administering to soil within the immediate vicinity of a plant, seedling, or seed, a liquid composition treatment comprising a culture of microalgae cells are disclosed. The liquid composition may comprise pasteurized Chlorella cells only, Aurantiochytrium acetophilum HS399 cells only, or a combination of Chlorella and Aurantiochytrium acetophilum HS399 cells that are pasteurized at a temperature between 65° C.-70° C.

### CROSS-REFERENCE TO RELATED APPLICATION

This Application claims the benefit of Provisional Application No. 62/572,363 entitled “SOIL ENHANCEMENT MATERIALS AND METHODS,” which was filed on Oct. 13, 2017 in the name of the Applicant and which is incorporated herein in full by reference.

### FIELD OF THE INVENTION

The present invention generally relates to agriculture and, more specifically, to soil enhancement materials and methods.

### BACKGROUND OF THE INVENTION

Whether at a commercial or home garden scale, growers are constantly striving to optimize the quality of soil to ensure a high return on the investment made in every growth season. As the population increases and the demand for raw plant materials goes up for the food and renewable technologies markets, the importance of efficient agricultural production intensifies. The influence of the environment on a plant's health and production has resulted in a need for strategies during the growth season which allow the plants to compensate for the influence of the environment and maximize production. Addition of nutrients to the soil or application to the foliage has been proposed to promote yield and quality in certain plants. The effectiveness can be attributable to the ingredients or the method of preparing the product. Increasing the effectiveness of a product can reduce the amount of the product needed and increase efficiency of the agricultural process. Therefore, there is a need in the art for methods of enhancing the quality of soil.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Embodiments of the invention relate to a composition for enhancing at least one plant characteristic. The composition can include a microalgae biomass that includes at least one species of microalgae. The composition can include a microalgae biomass that includes at least two species of microalgae. The composition can cause synergistic enhancement of at least one plant characteristic.

In some embodiments, the microalgae species can include Chlorella, Schizochytrium, Thraustochytrium, Oblongichytrium and/or Aurantiochytrium acetophilum HS399. In other embodiments, the microalgae species can include Botryococcus, Chlamydomonas, Scenedesmus, Pavlova, Phaeodactylum, Nannochloropsis, Spirlulina, Galdieria, Haematococcus, Isochrysis, Porphyridium, Tetraselmis, and/or the like.

In some embodiments, the microalgae biomass can include whole biomass and/or residual biomass. Whole biomass includes substantially all components and fractions of the cells from which the whole biomass is derived. Residual or extracted biomass can be any remaining biomass after extraction and/or removal of one or more components of a whole biomass.

In some embodiments, the composition can include one species of microalgae. In some embodiments, the composition can include a first species of microalgae and a second species of microalgae. The ratio of the first species of microalgae and the second species of microalgae can be between about 25:75, 50:50, or 75:25.

In some embodiments, the first species of microalgae may be Chlorella and the second species of microalgae may be Aurantiochytrium acetophilum HS399. In some embodiments, the ratio of Chlorella and Aurantiochytrium acetophilum HS399 may range between about 25:75 to 75:25. For example, the ratio of Chlorella and Aurantiochytrium acetophilum HS399 may be about 25:75, 50:50, or 75:25. In some embodiments, the Chlorella is whole biomass and Aurantiochytrium acetophilum HS399 is residual/extracted biomass. In some embodiments, the Aurantiochytrium acetophilum HS399 is whole biomass and Chlorella is residual/extracted biomass. In some embodiments, the Chlorella and Aurantiochytrium acetophilum HS399 are both whole biomass and in other embodiments the Chlorella and Aurantiochytrium acetophilum HS399 are both residual/extracted biomass.

Some embodiments of the invention relate to a method of plant enhancement comprising administering to a plant, seedling, seed, or soil the composition treatment, wherein the composition treatment enhances at least one plant characteristic. In some embodiments, the composition is applied when the plant is under salt stress conditions, temperature stress conditions, and/or the like.

Embodiments of the invention relate to a method of plant enhancement comprising administering a composition treatment comprising at least one microalgae species to soil. The administering can be by soil drench at the time of seeding. The method can include growing the plant to a transplant stage. The method can include transferring the plant at the transplant stage from an initial container to a larger container or a field, or the like. In some embodiments the plant at the transplant stage has at least one enhanced plant characteristic. The enhanced plant characteristic can be improved root density, improved root area, enhanced plant vigor, enhanced plant growth rate, enhanced plant maturation, and/or enhanced shoot development. After the transfer, the plant may have at least one enhanced plant characteristic. The composition treatment can include at least one microalgae species such as Botryococcus, Chlorella, Chlamydomonas, Scenedesmus, Pavlova, Phaeodactylum, Nannochloropsis, Aurantiochytrium, Spirlulina, Galdieria, Haematococcus, Isochrysis, Porphyridium, Schizochytrium, Tetraselmis, and/or the like.

In some of the embodiments and Examples below, the microalgae composition may be applied to the soil of the plant by drenching the soil (manually, by spray irrigation, or drip irrigation) initially at the time of transplant and then subsequently every 1-4 weeks after transplant until harvest. In other embodiments, the microalgae composition may be initially applied to the soil by mixing it with the soil during planting. In other embodiments, the microalgae composition may be added to the soil only once at the time or planting.

Prior patent applications containing useful background information and technical details are PCT/2015/066160, titled MIXOTROPHIC CHLORELLA-BASED COMPOSITION, AND METHODS OF ITS PREPARATION AND APPLICATION TO PLANTS, filed on Dec. 15, 2015; and PCT/US2017/037878 and PCT/US2017/037880, both applications titled MICROALGAE-BASED COMPOSITION, AND METHODS OF ITS PREPARATION AND APPLICATION TO PLANTS, both filed on Jun. 16, 2017. Each of these applications is incorporated herein by reference in its entirety.

Soil health is an integral feature of agriculture. It is a complex system comprised of biological, chemical, and physical components which work synergistically to provide the foundation upon which agriculture can be conducted. Soils treated with microalgae products were systematically tested in multiple platforms and using multiple testing modalities. This included both small and large-scale soil testing in greenhouse and field trials. Testing included submitting soil samples to a battery of soil health assays as well as community sequencing and quantifying functional genes. A similar pattern of product associated improvements to the microbial community and soil health was observed across multiple field trials and greenhouse experimental runs. Additionally, these similar improvements were observed across multiple field sites in two different states; California and Arizona. The application of microalgae products, such as PHYCOTERRA® Chlorella microalgae composition and the OMRI certified equivalent, TERRENE® Chlorella microalgae composition to the soil provides a distinct benefit to soil health and form an effective soil amendment option for both organic and non-organic growers.

Some key findings that will be described herein include: 1) Application of microalgae products is associated with shifts in the soil microbial community and these shifts involve increased abundance of beneficial soil microbes; 2) Soil treated with microalgae products are associated with increases in nitrogen-fixation functional gene abundance; and 3) Several soil health metrics are improved in soils treated with microalgae products; namely, active carbon, ACE-protein, soil water-holding capacity, and soil aggregation and these improvements were observed across several soil types in multiple geographic areas for certain metrics.

In accordance with one embodiment of the present invention, a method of improving health of soil is disclosed. The method comprises the step of administering to the soil a liquid composition treatment comprising a culture of microalgae, the microalgae comprising at least one of pasteurized Chlorella cells and pasteurized Aurantiochytrium acetophilum HS399 cells in an effective amount to improve at least one soil characteristic.

In accordance with another embodiment of the present invention, a method of improving health of soil is disclosed. The method comprises the step of administering to the soil a liquid composition treatment comprising a culture of microalgae, the microalgae comprising at least one of pasteurized Chlorella cells and pasteurized Aurantiochytrium acetophilum HS399 cells in an effective amount to at least one of increase an amount of active carbon in the soil, increase an amount of protein in the soil, increase an amount of healthy bacteria in the soil, increase an amount of nifH gene in the soil, increase an amount of nxrA gene in the soil, decrease an amount of total suspended solids lost in run-off from the soil, decrease an amount of total dissolved solids lost in run-off from the soil, increase water holding capacity of the soil, and increase soil aggregation.

In accordance with another embodiment of the present invention, a method of improving health of soil is disclosed. The method comprises the steps of: providing a liquid composition treatment comprising a culture of microalgae, the microalgae comprising at least one of pasteurized Chlorella cells and pasteurized Aurantiochytrium acetophilum HS399 cells; diluting the liquid composition treatment to contain between 1.2-24 g of the at least one of pasteurized Chlorella cells and pasteurized Aurantiochytrium acetophilum HS399 cells per gallon of carrier volume; and administering the liquid composition treatment to soil in the immediate vicinity of a plant, seedling, or seed in an effective amount to improve at least one soil characteristic.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present application is further detailed with respect to the following drawings. These figures are not intended to limit the scope of the present application, but rather, illustrate certain attributes thereof.

FIG. 1 is a graph that shows trends for soil protein in soils treated with PHYCOTERRA® Chlorella microalgae composition and soils treated with Aurantiochytrium acetophilum HS399 microalgae composition;

FIG. 2 is a graph that shows trends for active carbon for soils treated with PHYCOTERRA® Chlorella microalgae composition and soils treated with Aurantiochytrium acetophilum HS399 microalgae composition;

FIG. 3 is a graph that shows trends for soil aggregation for soils treated with PHYCOTERRA® Chlorella microalgae composition and soils treated with Aurantiochytrium acetophilum HS399 microalgae composition;

FIG. 4 is a graph that shows the soil protein and active carbon trends for soils treated with the Aurantiochytrium acetophilum HS399 whole biomass (WB) microalgae composition, soils treated with the PHYCOTERRA® Chlorella microalgae composition, and soils treated with the OMRI certified TERRENE® Chlorella microalgae composition;

FIG. 5 is a graph that shows the water holding capacity and soil aggregation trends for soils treated with the Aurantiochytrium acetophilum HS399 whole biomass (WB) microalgae composition, soils treated with the PHYCOTERRA® Chlorella microalgae composition, and soils treated with the OMRI certified TERRENE® Chlorella microalgae composition;

FIG. 6 is a graph that shows the soil protein, active carbon, and soil water holding capacity trend lines for soil treated a single application of the Aurantiochytrium acetophilum HS399 whole biomass (WB) microalgae composition and soils treated with a single application of the OMRI certified TERRENE® Chlorella microalgae composition;

FIG. 7 is a graph showing a water holding capacity histogram for soils treated with the PHYCOTERRA® Chlorella microalgae composition, soils treated with the Aurantiochytrium acetophilum HS399 whole biomass (WB) microalgae composition, and soils treated with the Aurantiochytrium acetophilum HS399 extracted biomass (EB) microalgae composition at stress conditions;

FIG. 8 is a table that shows raw data for soil that was treated with the Aurantiochytrium acetophilum HS399 whole biomass (WB) microalgae composition and soil treated with the OMRI certified TERRENE® Chlorella microalgae composition;

FIG. 9 is a graph that shows active carbon, water holding capacity, and soil aggregation trends for soils treated with the OMRI certified TERRENE® Chlorella microalgae composition and soils treated with the Aurantiochytrium acetophilum HS399 whole biomass (WB) microalgae composition;

FIG. 10 is a graph that shows a dry biomass comparison on harvested alfalfa shoots and roots for soils treated with the OMRI certified TERRENE® Chlorella microalgae composition and soils treated with the Aurantiochytrium acetophilum HS399 whole biomass (WB) microalgae composition;

FIG. 11 is a graph that shows aggregation and dry root biomass results from soils treated with the OMRI certified TERRENE® Chlorella microalgae composition;

FIG. 12 is a table that shows raw data for active carbon, soil protein, water holding capacity, total dissolved solids, total suspended solids, and soil aggregation for soils treated with the OMRI certified TERRENE® Chlorella pasteurized at 65° C. microalgae composition;

FIG. 13 is a table that shows raw data for active carbon, soil protein, water holding capacity, total dissolved solids, and total suspended solids for soil treated with the OMRI certified TERRENE® Chlorella microalgae composition, soil treated with the Aurantiochytrium acetophilum HS399 whole biomass (WB) microalgae composition, soil treated with the organic Aurantiochytrium acetophilum HS399 extracted biomass (EB) microalgae composition, and soil treated with the combination 25% Chlorella: 75% HS399 whole biomass (WB) microalgae composition;

FIG. 14 is a graph that shows a comparison of the changes in active carbon levels in soils treated with the microalgae compositions of FIG. 13;

FIG. 15 is a graph showing the active carbon and total dissolved solids at final harvest in soil treated with the OMRI certified TERRENE® Chlorella microalgae composition, soil treated with the organic Aurantiochytrium acetophilum HS399 extracted biomass (EB) microalgae composition, soil treated with the Aurantiochytrium acetophilum HS399 whole biomass (WB) microalgae composition, soil treated with the PHYCOTERRA® Chlorella microalgae composition, and soil treated with the Greenwater Polyculture microalgae composition;

FIG. 16 is a graph showing relative changes of water holding capacity with the OMRI certified TERRENE® Chlorella microalgae composition compared to the control over a 40-day course;

FIG. 17 is a graph showing the total suspended solids (ppm) and total dissolved solids (ppm) trendlines for coarse, medium, and fine soil textures treated with the microalgae composition of FIG. 16;

FIG. 18 a graph showing soil aggregation improvement in coarse, medium, and fine soil textures treated with the microalgae composition of FIG. 16;

FIG. 19 is a graph showing soil aggregation improvement in several soil types treated with the microalgae composition on FIG. 16;

FIG. 20 shows a Boxplot of Bray Curtis dissimilarity scores grouped by treatment type for soils treated with the Aurantiochytrium acetophilum HS399 whole biomass (WB) microalgae composition and the PHYCOTERRA® Chlorella microalgae composition (GP2C);

FIG. 21 is a graph that shows actual sequence variant (OTU) counts for three differentially abundant genera (Nitrospira, Gaeilla, and Bacillus) as they appear in the soils treated with the PHYCOTERRA® Chlorella microalgae composition (GP2C) and the soils treated with the Aurantiochytrium acetophilum HS399 microalgae composition;

FIG. 22 is chart showing the relative changes in nifH gene abundance in soils treated with the PHYCOTERRA® Chlorella microalgae composition (GP2C), the Aurantiochytrium acetophilum HS399 whole biomass (WB) microalgae composition, the Aurantiochytrium acetophilum HS399 extracted biomass (EB) microalgae composition, Spirulina microalgae composition, Isochrysis microalgae composition, and GWP; and

FIG. 23 is a chart showing the relative changes in nxrA gene abundance in soils treated with the PHYCOTERRA® Chlorella microalgae composition (GP2C), the Aurantiochytrium acetophilum HS399 whole biomass (WB) microalgae composition, the Aurantiochytrium acetophilum HS399 extracted biomass (EB) microalgae composition, Spirulina microalgae composition, Isochrysis microalgae composition, and GWP.

### DETAILED DESCRIPTION OF THE INVENTION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

Soil Health (also known as soil quality) tests have traditionally focused on soil texture, chemical concentrations such as nitrogen (N), phosphorus (P), potassium (K), and other macro or micro nutrients, etc. Adding inorganic fertilizers and tilling agricultural land increased productivity in the short run, but these practices had a negative impact on soil health and productivity in the long run. Current agricultural management practices focus on conserving and improving soil by treating it as a living system. The soil microbiome and its interactions with abiotic factors of soil provide insights into improving stable soil organic matter and water conservation. The suite of soil health assays used by the Applicant put the interactions between physical, chemical, and biological factors at the forefront of soil quality analysis. These are used to directly measure impacts of microalgae products on overall soil quality.

Physical components of soil quality are tested to determine attributes beyond simple soil texture. The water holding capacity of a soil is a very important agronomic characteristic. Total water holding capacity estimates the amount of moisture held in soil after drainage and has a direct relationship to plant available water (Viji et al 2012). Total dissolved solids and total suspended solids approximate the amount of nutrients and soil lost to runoff water. Testing soil aggregation yields important information on how soil influences and is influenced by the microorganisms inside it (Dinel et al 1992), as well as how effectively air and water exchange take place within the soil. Assessment of pH and electroconductivity is essential to monitoring soil health due to the significant effects on agricultural productivity.

Tests examining the biological factors present in soil, active carbon and soil protein, are particularly important as major soil health indicators. Active carbon, as labile soil organic carbon, serves as a readily available food and energy source for the soil microbial community. It is primarily influenced by ‘new’ organic matter (originating from plants, animals, or biological products used in the field). Active carbon is highly correlated with particular organic matter (POM), which is determined with a more complex and labor-intensive chemical extraction procedure. Soil protein content is well associated with overall soil health status because of its indication of biological and chemical soil health, in particular, the quality of soil organic matter. As organically bound nitrogen, it influences the ability of the soil to store nitrogen and make it available for plant uptake through soil microbial activity. Both tests respond to soil and crop management much more rapidly than total organic matter and have been associated with soil aggregation and therefore water storage and movement.

Combining the information from all these tests creates a more complete and concise view of overall soil health and how different factors combine to create changes in the soil. Modern farming practices put a new focus on the importance of organic matter in supporting healthy and sustainable agriculture. However, measuring changes due to organic matter in soil requires a significant amount of time (often years). The assays detailed in this document provide a more up-to-the-minute look into soil health and supply valuable information on the relationship between physical, chemical, and biological properties and how these properties are altered by the addition of various microalgae products.

To achieve these improvements in soil health, a low-concentration microalgae-based composition, in a dried or liquid solution form was used. Microalgae can be grown in heterotrophic, mixotrophic, and phototrophic conditions. Culturing microalgae in heterotrophic conditions comprises supplying organic carbon (e.g., acetic acid, acetate, glucose) to cells in an aqueous culture medium comprising trace metals and nutrients (e.g., nitrogen, phosphorus). Culturing microalgae in mixotrophic conditions comprises supplying light and organic carbon (e.g., acetic acid, acetate, glucose) to cells in an aqueous culture medium comprising trace metals and nutrients (e.g., nitrogen, phosphorus). Culturing microalgae in phototrophic conditions comprises supplying light and inorganic carbon (e.g., carbon dioxide) to cells in an aqueous culture medium comprising trace metals and nutrients (e.g., nitrogen, phosphorus).

In some embodiments, the microalgae cells can be harvested from a culture and used as whole cells in a liquid composition for application to seeds and plants, while in other embodiments the harvested microalgae cells can be subjected to downstream processing and the resulting biomass or extract can be used in a dried composition (e.g., powder, pellet) or a liquid composition (e.g., suspension, solution) for application to plants, soil, or a combination thereof. Non-limiting examples of downstream processing comprise: drying the cells, lysing the cells, and subjecting the harvested cells to a solvent or supercritical carbon dioxide extraction process to isolate an oil or protein. In some embodiments, the extracted (i.e., residual) biomass remaining from an extraction process can be used alone or in combination with other microalgae or extracts in a liquid composition for application to plants, soil, or a combination thereof. By subjecting the microalgae to an extraction process the resulting biomass is transformed from a natural whole state to a lysed condition where the cell is missing a significant amount of the natural components, thus differentiating the extracted microalgae biomass from that which is found in nature. Excreted products from the microalgae can also be isolated from a microalgae culture using downstream processing methods.

In some embodiments, microalgae can be the predominant active ingredient source in the composition. In some embodiments, the microalgae population of the composition can include whole biomass, substantially extracted biomass, excreted products (e.g., EPS), extracted protein, or extracted oil. In some embodiments, microalgae include at least 99% of the active ingredient sources of the composition. In some embodiments, microalgae include at least 95% of the active ingredient sources of the composition. In some embodiments, microalgae include at least 90% of the active ingredient sources of the composition. In some embodiments, microalgae include at least 80% of the active ingredient sources of the composition. In some embodiments, microalgae include at least 70% of the active ingredient sources of the composition. In some embodiments, microalgae include at least 60% of the active ingredient sources of the composition. In some embodiments, microalgae include at least 50% of the active ingredient sources of the composition. In some embodiments, microalgae include at least 40% of the active ingredient sources of the composition. In some embodiments, microalgae include at least 30% of the active ingredient sources of the composition. In some embodiments, microalgae include at least 20% of the active ingredient sources of the composition. In some embodiments, microalgae include at least 10% of the active ingredient sources of the composition. In some embodiments, microalgae include at least 5% of the active ingredient sources of the composition. In some embodiments, microalgae include at least 1% of the active ingredient sources of the composition. In some embodiments, the composition lacks any detectable amount of any other active ingredient source other than microalgae.

In some embodiments, microalgae biomass, excreted products, or extracts can also be mixed with biomass or extracts from other plants, microalgae, macroalgae, seaweeds, and kelp. In some embodiments, microalgae biomass, excreted products, or extracts can also be mixed with fish oil. Non-limiting examples of other plants, macroalgae, seaweeds, and kelp fractions that can be combined with microalgae cells can include species of Lemna, Gracilaria, Kappaphycus, Ascophyllum, Macrocystis, Fucus, Laminaria, Sargassum, Turbinaria, and Durvilea. In further embodiments, the extracts can comprise, but are not limited to, liquid extract from a species of Kappaphycus. In some embodiments, the extracts can include 50% or less by volume of the composition. In some embodiments, the extracts can include 40% or less by volume of the composition. In some embodiments, the extracts can include 30% or less by volume of the composition. In some embodiments, the extracts can include 20% or less by volume of the composition. In some embodiments, the extracts can include 10% or less by volume of the composition. In some embodiments, the extracts can include 5% or less by volume of the composition. In some embodiments, the extracts can include 4% or less by volume of the composition. In some embodiments, the extracts can include 3% or less by volume of the composition. In some embodiments, the extracts can include 2% or less by volume of the composition. In some embodiments, the extracts can include 1% or less by volume of the composition.

The term “microalgae” refers to microscopic single cell organisms such as microalgae, cyanobacteria, algae, diatoms, dinoflagellates, freshwater organisms, marine organisms, or other similar single cell organisms capable of growth in phototrophic, mixotrophic, or heterotrophic culture conditions.

In some embodiments, microalgae biomass, excreted product, or extracts can also be sourced from multiple types of microalgae, to make a composition that is beneficial when applied to plants or soil. Non-limiting examples of microalgae that can be used in the compositions and methods of the present invention include microalgae in the classes: Eustigmatophyceae, Chlorophyceae, Prasinophyceae, Haptophyceae, Cyanidiophyceae, Prymnesiophyceae, Porphyridiophyceae, Labyrinthulomycetes, Trebouxiophyceae, Bacillariophyceae, and Cyanophyceae. The class Cyanidiophyceae includes species of Galdieria. The class Chlorophyceae includes species of Haematococcus, Scenedesmus, Chlamydomonas, and Micractinium. The class Prymnesiophyceae includes species of Isochrysis and Pavlova. The class Eustigmatophyceae includes species of Nannochloropsis. The class Porphyridiophyceae includes species of Porphyridium. The class Labyrinthulomycetes includes species of Schizochytrium and Aurantiochytrium. The class Prasinophyceae includes species of Tetraselmis. The class Trebouxiophyceae includes species of Chlorella and Botryococcus. The class Bacillariophyceae includes species of Phaeodactylum. The class Cyanophyceae includes species of Spirulina.

Non-limiting examples of microalgae genus and species that can be used in the compositions and methods of the present invention include: Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Aurantiochytrium sp., Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomonas sp., Chlamydomas perigranulata, Chlorella anitrata, Chlorella antarctica, Chlorella aureoviridis, Chlorella Candida, Chlorella capsulate, Chlorella desiccate, Chlorella ellipsoidea, Chlorella emersonii, Chlorella fusca, Chlorella fusca var. vacuolate, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella sauna, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Galdieria sp., Gleocapsa sp., Gloeothamnion sp., Haematococcus pluvialis, Hymenomonas sp., Isochrysis a.ff galbana, Isochrysis galbana, Lepocinclis, Micractinium, Monoraphidium minutum, Monoraphidium sp., Nannochloris sp., Nannochloropsis salina, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Platymonas sp., Pleurochrysis camerae, Pleurochrysis dentate, Pleurochrysis sp., Porphyridium sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf, Tagetes erecta, Tagetes patula, Tetraedron, Tetraselmis sp., Tetraselmis suecica, Thalassiosira weissflogii, and Viridiella fridericiana.

Analysis of the DNA sequence of the strain of Chlorella sp. described in the specification was done in the NCBI 18s rDNA reference database at the Culture Collection of Algae at the University of Cologne (CCAC) showed substantial similarity (i.e., greater than 95%) with multiple known strains of Chlorella and Micractinium. Those of skill in the art will recognize that Chlorella and Micractinium appear closely related in many taxonomic classification trees for microalgae, and strains and species may be re-classified from time to time. Thus, for references throughout the instant specification for Chlorella sp., it is recognized that microalgae strains in related taxonomic classifications with similar characteristics to the reference Chlorella sp. strain would reasonably be expected to produce similar results.

Additionally, taxonomic classification has also been in flux for organisms in the genus Schizochytrium. Some organisms previously classified as Schizochytrium have been reclassified as Aurantiochytrium, Thraustochytrium, or Oblongichytrium. See Yokoyama et al. Taxonomic rearrangement of the genus Schizochytrium [sensu lato] based on morphology, chemotaxonomic characteristics, and 18S rRNA gene phylogeny (Thrausochytriaceae, Labyrinthulomycetes): emendation for Schizochytrium and erection of Aurantiochytrium and Oblongichytrium gen. nov. Mycoscience (2007) 48:199-211. Those of skill in the art will recognize that Schizochytrium, Aurantiochytrium, Thraustochytrium, and Oblongichytrium appear closely related in many taxonomic classification trees for microalgae, and strains and species may be re-classified from time to time. Thus, for references throughout the instant specification for Schizochytrium, it is recognized that microalgae strains in related taxonomic classifications with similar characteristics to Schizochytrium would reasonably be expected to produce similar results.

By artificially controlling aspects of the microalgae culturing process such as the organic carbon feed (e.g., acetic acid, acetate), oxygen levels, pH, and light, the culturing process differs from the culturing process that microalgae experiences in nature. In addition to controlling various aspects of the culturing process, intervention by human operators or automated systems occurs during the non-axenic mixotrophic culturing of microalgae through contamination control methods to prevent the microalgae from being overrun and outcompeted by contaminating organisms (e.g., fungi, bacteria). Contamination control methods for microalgae cultures are known in the art and such suitable contamination control methods for non-axenic mixotrophic microalgae cultures are disclosed in W02014/074769A2 (Ganuza, et al.), hereby incorporated by reference. By intervening in the microalgae culturing process, the impact of the contaminating microorganisms can be mitigated by suppressing the proliferation of containing organism populations and the effect on the microalgal cells (e.g., lysing, infection, death, clumping). Thus, through artificial control of aspects of the culturing process and intervening in the culturing process with contamination control methods, the microalgae culture produced as a whole and used in the described inventive compositions differs from the culture that results from a microalgae culturing process that occurs in nature.

During the mixotrophic culturing process the microalgae culture can also include cell debris and compounds excreted from the microalgae cells into the culture medium. The output of the microalgae mixotrophic culturing process provides the active ingredient for composition that is applied to plants for improving yield and quality without separate addition to or supplementation of the composition with other active ingredients not found in the mixotrophic microalgae whole cells and accompanying culture medium from the mixotrophic culturing process such as, but not limited to: microalgae extracts, macroalgae, macroalgae extracts, liquid fertilizers, granular fertilizers, mineral complexes (e.g., calcium, sodium, zinc, manganese, cobalt, silicon), fungi, bacteria, nematodes, protozoa, digestate solids, chemicals (e.g., ethanolamine, borax, boric acid), humic acid, nitrogen and nitrogen derivatives, phosphorus rock, pesticides, herbicides, insecticides, enzymes, plant fiber (e.g., coconut fiber).

In some embodiments, the microalgae can be previously frozen and thawed before inclusion in the liquid composition. In some embodiments, the microalgae may not have been subjected to a previous freezing or thawing process. In some embodiments, the microalgae whole cells have not been subjected to a drying process. The cell walls of the microalgae of the composition have not been lysed or disrupted, and the microalgae cells have not been subjected to an extraction process or process that pulverizes the cells. The microalgae whole cells are not subjected to a purification process for isolating the microalgae whole cells from the accompanying constituents of the culturing process (e.g., trace nutrients, residual organic carbon, bacteria, cell debris, cell excretions), and thus the whole output from the microalgae culturing process comprising whole microalgae cells, culture medium, cell excretions, cell debris, bacteria, residual organic carbon, and trace nutrients, is used in the liquid composition for application to plants. In some embodiments, the microalgae whole cells and the accompanying constituents of the culturing process are concentrated in the composition. In some embodiments, the microalgae whole cells and the accompanying constituents of the culturing process are diluted in the composition to a low concentration. The microalgae whole cells of the composition are not fossilized. In some embodiments, the microalgae whole cells are not maintained in a viable state in the composition for continued growth after the method of using the composition in a soil or foliar application. In some embodiments, the microalgae base composition can be biologically inactive after the composition is prepared. In some embodiments, the microalgae base composition can be substantially biologically inactive after the composition is prepared. In some embodiments, the microalgae base composition can increase in biological activity after the prepared composition is exposed to air.

In some embodiments, a liquid composition can include low concentrations of bacteria contributing to the solids percentage of the composition in addition to the microalgae cells. Examples of bacteria found in non-axenic mixotrophic conditions can be found in W02014/074769A2 (Ganuza, et al.), hereby incorporated by reference. A live bacteria count can be determined using methods known in the art such as plate counts, plates counts using Petrifilm available from 3M (St. Paul, Minn.), spectrophotometric (turbidimetric) measurements, visual comparison of turbidity with a known standard, direct cell counts under a microscope, cell mass determination, and measurement of cellular activity. Live bacteria counts in a non-axenic mixotrophic microalgae culture can range from 10⁴ to 10⁹ CFU/mL, and can depend on contamination control measures taken during the culturing of the microalgae. The level of bacteria in the composition can be determined by an aerobic plate count which quantifies aerobic colony forming units (CFU) in a designated volume. In some embodiments, the composition includes an aerobic plate count of 40,000-400,000 CFU/mL. In some embodiments, the composition includes an aerobic plate count of 40,000-100,000 CFU/mL. In some embodiments, the composition includes an aerobic plate count of 100,000-200,000 CFU/mL. In some embodiments, the composition includes an aerobic plate count of 200,000-300,000 CFU/mL. In some embodiments, the composition includes an aerobic plate count of 300,000-400,000 CFU/mL.

In some embodiments, the microalgae based composition can be supplemented with a supplemental nutrient such as nitrogen, phosphorus, or potassium to increase the levels within the composition to at least 1% of the total composition (i.e., addition of N, P, or K to increase levels at least 1-0-0, 0-1-0, 0-0-1, or combinations thereof). In some embodiments, the microalgae composition can be supplemented with nutrients such as, but not limited to, calcium, magnesium, silicon, sulfur, iron, manganese, zinc, copper, boron, molybdenum, chlorine, sodium, aluminum, vanadium, nickel, cerium, dysprosium, erbium, europium, gadolinium, holmium, lanthanum, lutetium, neodymium, praseodymium, promethium, samarium, scandium, terbium, thulium, ytterbium, and yttrium. In some embodiments, the supplemented nutrient is not uptaken, chelated, or absorbed by the microalgae. In some embodiments, the concentration of the supplemental nutrient can include 1-50 g per 100 g of the composition.

A liquid composition comprising microalgae can be stabilized by heating and cooling in a pasteurization process. As shown in the Examples, the inventors found that the active ingredients of the microalgae based composition maintained effectiveness in at least one characteristic of a plant after being subjected to the heating and cooling of a pasteurization process. In other embodiments, liquid compositions with whole cells or processed cells (e.g., dried, lysed, extracted) of microalgae cells may not need to be stabilized by pasteurization. For example, microalgae cells that have been processed, such as by drying, lysing, and extraction, or extracts can include such low levels of bacteria that a liquid composition can remain stable without being subjected to the heating and cooling of a pasteurization process.

In some embodiments, the composition can be heated to a temperature in the range of 50-130° C. In some embodiments, the composition can be heated to a temperature in the range of 55-65° C. In some embodiments, the composition can be heated to a temperature in the range of 58-62° C. In some embodiments, the composition can be heated to a temperature in the range of 50-60° C. In some embodiments, the composition can be heated to a temperature in the range of 60-90° C. In some embodiments, the composition can be heated to a temperature in the range of 70-80° C. In some embodiments, the composition can be heated to a temperature in the range of 100-150° C. In some embodiments, the composition can be heated to a temperature in the range of 120-130° C.

In some embodiments, the composition can be heated for a time period in the range of 1-150 minutes. In some embodiments, the composition can be heated for a time period in the range of 110-130 minutes. In some embodiments, the composition can be heated for a time period in the range of 90-100 minutes. In some embodiments, the composition can be heated for a time period in the range of 100-110 minutes. In some embodiments, the composition can be heated for a time period in the range of 110-120 minutes. In some embodiments, the composition can be heated for a time period in the range of 120-130 minutes. In some embodiments, the composition can be heated for a time period in the range of 130-140 minutes. In some embodiments, the composition can be heated for a time period in the range of 140-150 minutes. In some embodiments, the composition is heated for less than 15 min. In some embodiments, the composition is heated for less than 2 min.

After the step of heating or subjecting the liquid composition to high temperatures is complete, the compositions can be cooled at any rate to a temperature that is safe to work with. In one non-limiting embodiment, the composition can be cooled to a temperature in the range of 35-45° C. In some embodiments, the composition can be cooled to a temperature in the range of 36-44° C. In some embodiments, the composition can be cooled to a temperature in the range of 37-43° C. In some embodiments, the composition can be cooled to a temperature in the range of 38-42° C. In some embodiments, the composition can be cooled to a temperature in the range of 39-41° C. In further embodiments, the pasteurization process can be part of a continuous production process that also involves packaging, and thus the liquid composition can be packaged (e.g., bottled) directly after the heating or high temperature stage without a cooling step.

In some embodiments, the composition can include 5-30% solids by weight of microalgae cells (i.e., 5-30 g of microalgae cells/100 mL of the liquid composition). In some embodiments, the composition can include 5-20% solids by weight of microalgae cells. In some embodiments, the composition can include 5-15% solids by weight of microalgae cells. In some embodiments, the composition can include 5-10% solids by weight of microalgae cells. In some embodiments, the composition can include 10-20% solids by weight of microalgae cells. In some embodiments, the composition can include 10-20% solids by weight of microalgae cells. In some embodiments, the composition can include 20-30% solids by weight of microalgae cells. In some embodiments, further dilution of the microalgae cells percent solids by weight can occur before application for low concentration applications of the composition.

In some embodiments, the composition can include less than 1% by weight of microalgae biomass or extracts (i.e., less than 1 g of microalgae derived product/100 mL of the liquid composition). In some embodiments, the composition can include less than 0.9% by weight of microalgae biomass or extracts. In some embodiments, the composition can include less than 0.8% by weight of microalgae biomass or extracts. In some embodiments, the composition can include less than 0.7% by weight of microalgae biomass or extracts. In some embodiments, the composition can include less than 0.6% by weight of microalgae biomass or extracts. In some embodiments, the composition can include less than 0.5% by weight of microalgae biomass or extracts. In some embodiments, the composition can include less than 0.4% by weight of microalgae biomass or extracts. In some embodiments, the composition can include less than 0.3% by weight of microalgae biomass or extracts. In some embodiments, the composition can include less than 0.2% by weight of microalgae biomass or extracts. In some embodiments, the composition can include less than 0.1% by weight of microalgae biomass or extracts. In some embodiments, the composition can include at least 0.0001% by weight of microalgae biomass or extracts. In some embodiments, the composition can include at least 0.001% by weight of microalgae biomass or extracts. In some embodiments, the composition can include at least 0.01% by weight of microalgae biomass or extracts. In some embodiments, the composition can include at least 0.1% by weight of microalgae biomass or extracts. In some embodiments, the composition can include 0.0001-1% by weight of microalgae biomass or extracts. In some embodiments, the composition can include 0.0001-0.001% by weight of microalgae biomass or extracts. In some embodiments, the composition can include 0.001-0.01% by weight of microalgae biomass or extracts. In some embodiments, the composition can include 0.01-0.1% by weight of microalgae biomass or extracts. In some embodiments, the composition can include 0.1-1% by weight of microalgae biomass or extracts.

In some embodiments, an application concentration of 0.1% of microalgae biomass or extract equates to 0.04 g of microalgae biomass or extract in 40 mL of a composition. While the desired application concentration to a plant can be 0.1% of microalgae biomass or extract, the composition can be packaged as a 10% concentration (0.4 mL in 40 mL of a composition). Thus, a desired application concentration of 0.1% would require 6,000 mL of the 10% microalgae biomass or extract in the 100 gallons of water applied to the assumption of 15,000 plants in an acre, which is equivalent to an application rate of about 1.585 gallons per acre. In some embodiments, a desired application concentration of 0.01% of microalgae biomass or extract using a 10% concentration composition equates to an application rate of about 0.159 gallons per acre. In some embodiments, a desired application concentration of 0.001% of microalgae biomass or extract using a 10% concentration composition equates to an application rate of about 0.016 gallons per acre. In some embodiments, a desired application concentration of 0.0001% of microalgae biomass or extract using a 10% concentration composition equates to an application rate of about 0.002 gallons per acre.

In another non-limiting embodiment, correlating the application of the microalgae biomass or extract on a per plant basis using the assumption of 15,000 plants per acre, the composition application rate of 1 gallon per acre is equal to about 0.25 mL per plant=0.025 g per plant=25 mg of microalgae biomass or extract per plant. The water requirement assumption of 100 gallons per acre is equal to about 35 mL of water per plant. Therefore, 0.025 g of microalgae biomass or extract in 35 mL of water is equal to about 0.071 g of microalgae biomass or extract per 100 mL of composition equates to about a 0.07% application concentration. In some embodiments, the microalgae biomass or extract based composition can be applied at a rate in a range as low as about 0.001-10 gallons per acre, or as high as up to 150 gallons per acre.

In some of the embodiments and Examples below, the applications were performed using a 10% solids solution by weight microalgae composition. For greenhouse trials, the rates vary and essentially refer to how much volume of the 10% solids solution was added in a given volume of water (e.g. 0.3% v/v-3.0% v/v). For example, in a greenhouse trial, 3 L of soil may be mixed with 1000 mL of treatment solution and thoroughly mixed together to create the 3% v/v treatment application. For field trials, the rates are indicated in gal/acre and the amount of carrier water would be determined according to user preference. For field trials, the application rate may range between 0.5 gal/acre-6 gal/acre. For example, in the greenhouse trial where the application rate is 0.3% v/v, the microalgae composition would contain 1.2 g of microalgae/gal and where the application rate is 3.0% v/v, the microalgae composition would contain 12 g of microalgae/gal of carrier volume. In the field trials, where the application rate of the microalgae composition is 0.5 gal/acre, the equivalent expressed in total grams of solid microalgae would be 200 g microalgae/acre; where the application rate of the microalgae composition is 1.0 gal/acre, the equivalent expressed in total grams of solid microalgae would be 400 g microalgae/acre; where the application rate of the microalgae composition is 3.0 gal/acre, the equivalent expressed in total grams of solid microalgae would be 1,200 g microalgae/acre; where the application rate of the microalgae composition is 6.0 gal/acre, the equivalent expressed in total grams of solid microalgae would be 2,400 g microalgae/acre.

Overall, as shown in the embodiments and Examples below, the microalgae composition may comprise between 1.2-24 g of microalgae per gallon of carrier volume, as it is common practice for growers to use between 100-250 gallons of liquid carrier volume/acre. It should be clearly understood, however, that modifications to the amount of microalgae per gallon may be adjusted upwardly or downwardly to compensate for greater than 250 gallons of liquid carrier volume/acre or less than 100 gallons of liquid carrier volume/acre.

In some embodiments, stabilizing means that are not active regarding the improvement of plant germination, emergence, maturation, quality, and yield, but instead aid in stabilizing the composition can be added to prevent the proliferation of unwanted microorganisms (e.g., yeast, mold) and prolong shelf life. Such inactive but stabilizing means can include an acid, such as but not limited to phosphoric acid or citric acid, and a yeast and mold inhibitor, such as but not limited to potassium sorbate. In some embodiments, the stabilizing means are suitable for plants and do not inhibit the growth or health of the plant. In the alternative, the stabilizing means can contribute to nutritional properties of the liquid composition, such as but not limited to, the levels of nitrogen, phosphorus, or potassium.

In some embodiments, the composition can include between 0.5-1.5% phosphoric acid. In other embodiments, the composition may comprise less than 0.5% phosphoric acid. In some embodiments, the composition can include 0.01-0.3% phosphoric acid. In some embodiments, the composition can include 0.05-0.25% phosphoric acid. In some embodiments, the composition can include 0.01-0.1% phosphoric acid. In some embodiments, the composition can include 0.1-0.2% phosphoric acid. In some embodiments, the composition can include 0.2-0.3% phosphoric acid. In some embodiments, the composition can include less than 0.3% citric acid.

In some embodiments, the composition can include 1.0-2.0% citric acid. In other embodiments, the composition can include 0.01-0.3% citric acid. In some embodiments, the composition can include 0.05-0.25% citric acid. In some embodiments, the composition can include 0.01-0.1% citric acid. In some embodiments, the composition can include 0.1-0.2% citric acid. In some embodiments, the composition can include 0.2-0.3% citric acid.

In some embodiments, the composition can include less than 0.5% potassium sorbate. In some embodiments, the composition can include 0.01-0.5% potassium sorbate. In some embodiments, the composition can include 0.05-0.4% potassium sorbate. In some embodiments, the composition can include 0.01-0.1% potassium sorbate. In some embodiments, the composition can include 0.1-0.2% potassium sorbate. In some embodiments, the composition can include 0.2-0.3% potassium sorbate. In some embodiments, the composition can include 0.3-0.4% potassium sorbate. In some embodiments, the composition can include 0.4-0.5% potassium sorbate.

The present invention involves the use of a microalgae composition. Microalgae compositions, methods of preparing liquid microalgae compositions, and methods of applying the microalgae compositions to plants are disclosed in W02017/218896A1 (Shinde et al.) entitled Microalgae-Based Composition, and Methods of its Preparation and Application to Plants, which is incorporated herein in full by reference. In one or more embodiments, the microalgae composition may comprise approximately 10%-10.5% w/w of Chlorella microalgae cells. In one or more embodiments, the microalgae composition may also comprise one of more stabilizers, such as potassium sorbate, phosphoric acid, ascorbic acid, sodium benzoate, citric acid, or the like, or any combination thereof. For example, in one or more embodiments, the microalgae composition may comprise approximately 0.3% w/w of potassium sorbate or another similar compound to stabilize its pH and may further comprise approximately 0.5-1.5% w/w phosphoric acid or another similar compound to prevent the growth of contaminants. As a further example, in one or more embodiments where it is desired to use an OMRI (Organic Materials Review Institute) certified organic composition, the microalgae composition may comprise 1.0-2.0% w/w citric acid to stabilize its pH, and may not contain potassium sorbate or phosphoric acid. In one or more embodiments, the pH of the microalgae composition may be stabilized to between 3.0-4.0.

In some embodiments and Examples below, the microalgae composition may be referred to as PHYCOTERRA®. The PHYCOTERRA® Chlorella microalgae composition is a microalgae composition comprising Chlorella. The PHYCOTERRA® Chlorella microalgae composition treatments were prepared by growing the Chlorella in non-axenic acetic acid supplied mixotrophic conditions, increasing the concentration of Chlorella using a centrifuge, pasteurizing the concentrated Chlorella at between 65° C.-70° C. for between 90-150 minutes, adding potassium sorbate and phosphoric acid to stabilize the pH of the Chlorella, and then adjusting the whole biomass treatment to the desired concentration. The PHYCOTERRA® Chlorella microalgae composition may comprise approximately 10% w/w of Chlorella microalgae cells. Furthermore, the PHYCOTERRA® Chlorella microalgae composition may comprise between approximately 0.3% potassium sorbate and between approximately 0.5%-1.5% phosphoric acid to stabilize the pH of the Chlorella to between 3.0-4.0 and 88.2%-89.2% water. It should be clearly understood, however, that other variations of the PHYCOTERRA® Chlorella microalgae composition, including variations in the microalgae strains, variations in the stabilizers, and/or variations in the % composition of each component may be used and may achieve similar results.

In some embodiments and Examples below, the microalgae composition may be an OMRI certified microalgae composition referred to as TERRENE®. The OMRI certified TERRENE® Chlorella microalgae composition is a microalgae composition comprising Chlorella. The OMRI certified TERRENE® Chlorella microalgae composition treatments were prepared by growing the Chlorella in non-axenic acetic acid supplied mixotrophic conditions, increasing the concentration of Chlorella using a centrifuge, pasteurizing the concentrated Chlorella at between 65° C.-70° C. for between 90-150 minutes, adding citric acid to stabilize the pH of the Chlorella, and then adjusting the whole biomass treatment to the desired concentration. The OMRI certified TERRENE® Chlorella microalgae composition may comprise approximately 10% w/w of Chlorella microalgae cells. Furthermore, the OMRI certified TERRENE® Chlorella microalgae composition may comprise between approximately 0.5%-2.0% citric acid to stabilize the pH of the Chlorella to between 3.0-4.0 and 88%-89.5% water. It should be clearly understood, however, that other variations of the OMRI certified TERRENE® Chlorella microalgae composition, including variations in the microalgae strains, variations in the stabilizers, and/or variations in the % composition of each component may be used and may achieve similar results.

In some embodiments and Examples below, the microalgae composition may be an OMRI certified microalgae composition referred to as OMRI certified TERRENE® Chlorella pasteurized at 65° C. microalgae composition or as TERRENE65. The OMRI certified TERRENE® Chlorella pasteurized at 65° C. microalgae composition is a microalgae composition comprising Chlorella. The OMRI certified TERRENE® Chlorella pasteurized at 65° C. microalgae composition treatments were prepared by growing the Chlorella in non-axenic acetic acid supplied mixotrophic conditions, increasing the concentration of Chlorella using a centrifuge, pasteurizing the concentrated Chlorella at 65° C. for between 90-150 minutes, adding citric acid to stabilize the pH of the Chlorella, and then adjusting the whole biomass treatment to the desired concentration. The OMRI certified TERRENE® Chlorella pasteurized at 65° C. microalgae composition may comprise approximately 10% w/w of Chlorella microalgae cells. Furthermore, the OMRI certified TERRENE® Chlorella pasteurized at 65° C. microalgae composition may comprise between approximately 0.5%-2.0% citric acid to stabilize the pH of the Chlorella to between 3.0-4.0 and 88-89.5% water. It should be clearly understood, however, that other variations of the OMRI certified TERRENE® Chlorella pasteurized at 65° C. microalgae composition, including variations in the microalgae strains, variations in the stabilizers, variations in the pasteurization temperature, and/or variations in the % composition of each component may be used and may achieve similar results.

In some embodiments and Examples below, the microalgae composition may be referred to as Aurantiochytrium acetophilum HS399 whole biomass (WB) or HS399 WB. The Aurantiochytrium acetophilum HS399 whole biomass (WB) microalgae composition is a microalgae composition comprising Aurantiochytrium acetophilum HS399. The Aurantiochytrium acetophilum HS399 whole biomass (WB) microalgae composition treatments were prepared by growing the Aurantiochytrium acetophilum HS399 microalgae in non-axenic acetic acid supplied heterotrophic conditions, increasing the concentration of Aurantiochytrium acetophilum HS399 using a centrifuge, pasteurizing the concentrated Aurantiochytrium acetophilum HS399 at between 65° C.-70° C. for between 90-150 minutes, adding approximately 0.3% w/w of potassium sorbate and between approximately 0.5-1.5% phosphoric acid to stabilize the pH of the Aurantiochytrium acetophilum HS399 to between 3.0-4.0, and then adjusting the whole biomass to a desired concentration. It should be clearly understood that other variations of the Aurantiochytrium acetophilum HS399 whole biomass (WB) microalgae composition, including variations in the microalgae strains, variations in the stabilizers, variations in the pasteurization temperature, and/or variations in the % composition of each component may be used and may achieve similar results.

In some embodiments and Examples below, the microalgae composition may be referred to as Aurantiochytrium acetophilum HS399 washed whole biomass (WB washed). The Aurantiochytrium acetophilum HS399 washed whole biomass (WB washed) microalgae composition is a microalgae composition comprising Aurantiochytrium acetophilum HS399. The Aurantiochytrium acetophilum HS399 washed whole biomass (WB washed) microalgae composition treatments were prepared by growing the Aurantiochytrium acetophilum HS399 microalgae in non-axenic acetic acid supplied heterotrophic conditions, increasing the concentration of Aurantiochytrium acetophilum HS399 using a centrifuge, pasteurizing the concentrated Aurantiochytrium acetophilum HS399 at between 65° C.-70° C. for between 90-150 minutes, adding approximately 0.3% w/w of potassium sorbate and between approximately 0.5%-1.5% phosphoric acid to stabilize the pH of the Aurantiochytrium acetophilum HS399 to between 3.0-4.0, and then adjusting the whole biomass to a desired concentration. Once the Aurantiochytrium acetophilum HS399 microalgae cells were concentrated from the harvest, they were washed; i.e. diluted with water in a ratio of 5:1 and centrifuged again in order to remove dissolved material and small particles. It should be clearly understood that other variations of the Aurantiochytrium acetophilum HS399 washed whole biomass (WB washed) microalgae composition, including variations in the microalgae strains, variations in the stabilizers, variations in the pasteurization temperature, variations in the washing method, and/or variations in the % composition of each component may be used and may achieve similar results.

In some embodiments and Examples below, the microalgae composition may be referred to as Aurantiochytrium acetophilum HS399 extracted biomass (EB) or HS399 EB. The Aurantiochytrium acetophilum HS399 extracted biomass (EB) microalgae composition is a microalgae composition comprising Aurantiochytrium acetophilum HS399. The Aurantiochytrium acetophilum HS399 extracted biomass (EB) treatments were prepared by growing the Aurantiochytrium acetophilum HS399 microalgae in non-axenic acetic acid supplied heterotrophic conditions, increasing the concentration of Aurantiochytrium acetophilum HS399 using a centrifuge, pasteurizing the concentrated Aurantiochytrium acetophilum HS399 at between 65° C.-70° C. for between 90-150 minutes, adding approximately 0.3% w/w of potassium sorbate and between approximately 0.5%-1.5% phosphoric acid to stabilize the pH of the Aurantiochytrium acetophilum HS399 to between 3.0-4.0, processing the Aurantiochytrium acetophilum HS399 with an oat filler in an expeller process to lyse the cells and separate oil from the residual biomass, and then adjusting the residual biomass to a desired concentration. It should be clearly understood that other variations of the Aurantiochytrium acetophilum HS399 extracted biomass (EB) microalgae composition, including variations in the microalgae strains, variations in the stabilizers, variations in the pasteurization temperature, variations in the extraction method, and/or variations in the % composition of each component may be used and may achieve similar results.

In some embodiments and Examples below, the microalgae composition may be referred to as a combination 25% Chlorella: 75% HS399 whole biomass (WB) microalgae composition or 25% Chlorella: 75% HS399 WB. The combination 25% Chlorella: 75% HS399 whole biomass (WB) microalgae composition is a microalgae composition comprising Chlorella and Aurantiochytrium acetophilum HS399. For the combination 25% Chlorella: 75% HS399 whole biomass (WB) microalgae composition, the Chlorella microalgae cells were cultured in outdoor pond reactors in non-axenic acetic acid supplied mixotrophic conditions and the concentration of Chlorella was increased using a centrifuge. The Aurantiochytrium acetophilum HS399 cells were cultured in non-axenic acetic-acid supplied heterotrophic conditions and the concentration of HS399 was increased using a centrifuge. The concentrated Chlorella cells were then combined with the concentrated HS399 whole biomass cells and adjusted to the desired concentration of 25% Chlorella: 75% HS399 whole biomass (WB). The combination 25% Chlorella: 75% HS399 whole biomass (WB) microalgae composition was then pasteurized at between 65° C.-75° C. for between 90-150 minutes and then stabilized by adding approximately 0.3% w/w of potassium sorbate and between approximately 0.5%-1.5% phosphoric acid to stabilize the pH of the 25% Chlorella: 75% HS399 whole biomass (WB) microalgae composition to between 3.0-4.0. It should be clearly understood, however, that other variations of the combination 25% Chlorella: 75% HS399 whole biomass (WB) microalgae composition, including variations in the microalgae strains, variations in the stabilizers, variations in the order of the processing steps (blending, pasteurizing, stabilizing), and/or variations in the % composition of each component may be used and may achieve similar results.

In some embodiments and Examples below, the microalgae composition may be referred to as GP2C. The GP2C Chlorella microalgae composition comprised Chlorella. The GP2C Chlorella microalgae composition treatments were prepared by growing the Chlorella in non-axenic acetic acid supplied mixotrophic conditions, increasing the concentration of Chlorella using a centrifuge, pasteurizing the concentrated Chlorella at between 65° C.-70° C. for between 90-150 minutes, adding potassium sorbate and phosphoric acid to stabilize the pH of the Chlorella, and then adjusting the whole biomass treatment to the desired concentration. The GP2C Chlorella microalgae composition may comprise approximately 10% w/w of Chlorella microalgae cells. Furthermore, the GP2C microalgae composition may comprise between approximately 0.3% potassium sorbate and between approximately 05%-1.5% phosphoric acid to stabilize the pH of the Chlorella to between 3.0-4.0 and 88.2%-89% water. It should be clearly understood, however, that other variations of the GP2C Chlorella microalgae composition, including variations in the microalgae strains, variations in the stabilizers, and/or variations in the % composition of each component may be used and may achieve similar results.

In some embodiments and Examples below, the microalgae composition may be referred to as a Greenwater Polyculture (GWP) treatment. Greenwater Polyculture may be prepared by beginning with a culture of Scenedesmus microalgae that is left outdoors in an open pond and harvested continuously over a year. The culture may comprise anywhere from less than 50% Scenedesmus to greater than 75% Scenedesmus and the concentration varies throughout the year. Other algae may colonize in the GWP as well as other bacteria and microorganisms.

In some embodiments, the composition is a liquid and substantially includes of water. In some embodiments, the composition can include 70-99% water. In some embodiments, the composition can include 85-95% water. In some embodiments, the composition can include 70-75% water. In some embodiments, the composition can include 75-80% water. In some embodiments, the composition can include 80-85% water. In some embodiments, the composition can include 85-90% water. In some embodiments, the composition can include 90-95% water. In some embodiments, the composition can include 95-99% water. The liquid nature and high-water content of the composition facilitates administration of the composition in a variety of manners, such as but not limit to: flowing through an irrigation system, flowing through an above ground drip irrigation system, flowing through a buried drip irrigation system, flowing through a central pivot irrigation system, sprayers, sprinklers, and water cans.

In some embodiments, the liquid composition can be used immediately after formulation, or can be stored in containers for later use. In some embodiments, the composition can be stored out of direct sunlight. In some embodiments, the composition can be refrigerated. In some embodiments, the composition can be stored at 1-10° C. In some embodiments, the composition can be stored at 1-3° C. In some embodiments, the composition can be stored at 3-50° C. In some embodiments, the composition can be stored at 5-8° C. In some embodiments, the composition can be stored at 8-10° C.

In some non-limiting embodiment, the administration of the composition can include contacting the soil in the immediate vicinity of the planted seed with an effective amount of the composition. In some embodiments, the liquid composition can be supplied to the soil by injection into a low volume irrigation system, such as but not limited to a drip irrigation system supplying water beneath the soil through perforated conduits or at the soil level by fluid conduits hanging above the ground or protruding from the ground. In some embodiments, the liquid composition can be supplied to the soil by a soil drench method wherein the liquid composition is poured on the soil.

The composition can be diluted to a lower concentration for an effective amount in a soil application by mixing a volume of the composition in a volume of water. The percent solids of microalgae sourced components resulting in the diluted composition can be calculated by the multiplying the original concentration in the composition by the ratio of the volume of the composition to the volume of water. Alternatively, the grams of microalgae sourced components in the diluted composition can be calculated by the multiplying the original grams of microalgae sourced components per 100 mL by the ratio of the volume of the composition to the volume of water.

The rate of application of the composition at the desired concentration can be expressed as a volume per area. In some embodiments, the rate of application of the liquid composition in a soil application can include a rate in the range of 50-150 gallons/acre. In some embodiments, the rate of application of the liquid composition in a soil application can include a rate in the range of 75-125 gallons/acre. In some embodiments, the rate of application of the liquid composition in a soil application can include a rate in the range of 50-75 gallons/acre. In some embodiments, the rate of application of the liquid composition in a soil application can include a rate in the range of 75-100 gallons/acre. In some embodiments, the rate of application of the liquid composition in a soil application can include a rate in the range of 100-125 gallons/acre. In some embodiments, the rate of application of the liquid composition in a soil application can include a rate in the range of 125-150 gallons/acre.

In some embodiments, the rate of application of the liquid composition in a soil application can include a rate in the range of 10-50 gallons/acre. In some embodiments, the rate of application of the liquid composition in a soil application can include a rate in the range of 10-20 gallons/acre. In some embodiments, the rate of application of the liquid composition in a soil application can include a rate in the range of 20-30 gallons/acre. In some embodiments, the rate of application of the liquid composition in a soil application can include a rate in the range of 30-40 gallons/acre. In some embodiments, the rate of application of the liquid composition in a soil application can include a rate in the range of 40-50 gallons/acre.

In some embodiments, the rate of application of the liquid composition in a soil application can include a rate in the range of 0.01-10 gallons/acre. In some embodiments, the rate of application of the liquid composition in a soil application can include a rate in the range of 0.01-0.1 gallons/acre. In some embodiments, the rate of application of the liquid composition in a soil application can include a rate in the range of 0.1-1.0 gallons/acre. In some embodiments, the rate of application of the liquid composition in a soil application can include a rate in the range of 1-2 gallons/acre. In some embodiments, the rate of application of the liquid composition in a soil application can include a rate in the range of 2-3 gallons/acre. In some embodiments, the rate of application of the liquid composition in a soil application can include a rate in the range of 3-4 gallons/acre. In some embodiments, the rate of application of the liquid composition in a soil application can include a rate in the range of 4-5 gallons/acre. In some embodiments, the rate of application of the liquid composition in a soil application can include a rate in the range of 5-10 gallons/acre.

In some embodiments, the rate of application of the liquid composition in a soil application can include a rate in the range of 2-20 liters/acre. In some embodiments, the rate of application of the liquid composition in a soil application can include a rate in the range of 3.7-15 liters/acre. In some embodiments, the rate of application of the liquid composition in a soil application can include a rate in the range of 2-5 liters/acre. In some embodiments, the rate of application of the liquid composition in a soil application can include a rate in the range of 5-10 liters/acre. In some embodiments, the rate of application of the liquid composition in a soil application can include a rate in the range of 10-15 liters/acre. In some embodiments, the rate of application of the liquid composition in a soil application can include a rate in the range of 15-20 liters/acre.

Prior patent applications containing useful background information and technical details are PCT/US2017/053432 titled METHODS OF CULTURING AURANTIOCHYTRIUM USING ACETATE AS AN ORGANIC CARBON SOURCE, filed on Sep. 26, 2017; PCT/US2015/066160, titled MIXOTROPHIC CHLORELLA-BASED COMPOSITION, AND METHODS OF ITS PREPARATION AND APPLICATION TO PLANTS, filed on Dec. 15, 2015; and PCT/US2017/037878 and PCT/2017/037880, both applications titled MICROALGAE-BASED COMPOSITION, AND METHODS OF ITS PREPARATION AND APPLICATION TO PLANTS, both filed on Jun. 16, 2017. Each of these applications is incorporated herein by reference in its entirety.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto. All patents and references cited herein are explicitly incorporated by reference in their entirety.

### EXAMPLES

### Example 1

A trial was conducted to evaluate the effect of the PHYCOTERRA® Chlorella microalgae composition and the Aurantiochytrium acetophilum HS399 whole biomass (WB) microalgae composition on soil health. This trial incorporated a single application of the microalgae composition. A total of three runs were completed; Run 1 took place Mar. 22, 2017-Apr. 11, 2017, Run 2 took place Apr. 12, 2017-May 13, 2017; and Run 3 took place May 5, 2017-Jun. 4, 2017.

Arizona field soil (Antho sandy loam) was mixed with Sunshine Mix #4 at a 60:40 ratio v/v respectively. This mixture was then mixed further with 30% v/v perlite. 2.2 L aliquots of final mix were combined with product at various dilutions. 3 L of soil is mixed with 1000 mL of treatment solution and thoroughly mixed together to create the 3% v/v treatment application and the resulting treated soil was potted into 3 replicate quart pots. A sample of the final mix before treatment was obtained and samples of each quart pot were obtained. Quart pots were surrounded by a buffer layer of pots filled with sunshine mix. All collected samples were subjected to soil health analysis including soil active carbon, soil protein, and aggregate size distribution. Raw data for soil protein (Table 1), active carbon (Table 2), and soil aggregate >1 mm PMR (Table 3) are shown in the Tables below.

TABLE 1
Raw Data for Soil Protein

| Tests | Runs # | Treatments | Rates (v/v) | Day initial | Day 0 | Day 5 | Day 10 | Day 15 | Day 20 | Day 25 | Day 30 |
|---|---|---|---|---|---|---|---|---|---|---|---|
| Soil | Run 1 | standard | | 1.95 | 2.07 | 2.07 | 2.00 | 2.03 | 1.86 | | |
| Protein | | practice | | | | | | | | | |
| (mg/g) | | seaweed | 0.30% | 1.95 | 2.23 | 1.98 | 1.95 | 1.91 | 1.90 | | |
| | | commercial | | | | | | | | | |
| | | ref. | | | | | | | | | |
| | | PhycoTerra | 0.03% | 1.95 | 2.06 | 2.01 | 1.94 | 1.81 | 1.75 | | |
| | | PhycoTerra | 0.30% | 1.95 | 1.96 | 2.11 | 1.99 | 1.93 | 1.72 | | |
| | | PhycoTerra | 1% | 1.95 | 2.11 | 2.15 | 1.99 | 1.89 | 1.98 | | |
| | | HS399WB | 0.03% | 1.95 | 2.03 | 1.99 | 1.82 | 1.90 | 2.03 | | |
| | | HS399WB | 0.30% | 1.95 | 1.99 | 2.07 | 1.86 | 2.00 | 2.06 | | |
| | | HS399WB | 3% | 1.95 | 2.18 | 2.14 | 2.09 | 1.95 | 2.19 | | |
| | Run 2 | standard | | 1.95 | 2.31 | 2.10 | 1.54 | 1.70 | 1.48 | | |
| | | practice | | | | | | | | | |
| | | seaweed | 1.00% | 1.95 | 2.33 | 2.02 | 1.80 | 1.84 | 1.48 | | |
| | | commercial | | | | | | | | | |
| | | ref. | | | | | | | | | |
| | | PhycoTerra | 0.03% | 1.95 | 2.29 | 1.96 | 1.77 | 1.79 | 1.53 | | |
| | | PhycoTerra | 0.30% | 1.95 | 2.39 | 2.01 | 2.01 | 1.81 | 1.56 | | |
| | | PhycoTerra | 1% | 1.95 | 2.26 | 2.18 | 2.04 | 1.95 | 1.69 | | |
| | | HS399WB | 0.03% | 1.95 | 2.04 | 2.14 | 1.89 | 1.80 | 1.63 | | |
| | | HS399WB | 0.30% | 1.95 | 2.12 | 2.27 | 2.03 | 2.22 | 1.64 | | |
| | | HS399WB | 3% | 1.95 | 2.39 | 2.35 | 2.05 | 2.37 | 1.73 | | |
| | Run 3 | standard | | 0.98 | 0.98 | 1.67 | | 2.06 | | 1.41 | |
| | | practice | | | | | | | | | |
| | | seaweed | 0.30% | 0.98 | 1.37 | 2.01 | | 1.97 | | 1.46 | |
| | | commercial | | | | | | | | | |
| | | ref. | | | | | | | | | |
| | | PhycoTerra | 0.03% | 0.98 | 1.03 | 1.81 | | 2.09 | | 1.11 | |
| | | PhycoTerra | 0.30% | 0.98 | 1.04 | 1.85 | | 2.49 | | 1.28 | |
| | | PhycoTerra | 1% | 0.98 | 1.06 | 1.98 | | 2.57 | | 1.54 | |
| | | HS399WB | 0.03% | 0.98 | 1.14 | 1.73 | | 1.99 | | 1.09 | |
| | | HS399WB | 0.30% | 0.98 | 1.22 | 2.04 | | 2.00 | | 1.36 | |
| | | HS399WB | 3% | 0.98 | 1.47 | 2.28 | | 2.21 | | 1.74 | |

TABLE 2
Raw Data for Active Carbon

| Tests | Runs # | Treatments | Rates (v/v) | Day initial | Day 0 | Day 5 | Day 10 | Day 15 | Day 20 | Day 25 | Day 30 |
|---|---|---|---|---|---|---|---|---|---|---|---|
| Active | Run 1 | standard practice | | 486.05 | 487.26 | 611.00 | 644.37 | 663.18 | 527.67 | | |
| Carbon | | seaweed | 1.00% | 486.05 | 559.43 | 648.14 | 657.13 | 661.71 | 395.06 | | |
| (mg/kg) | | commercial ref. | | | | | | | | | |
| | | PhycoTerra | 0.03% | 436.05 | 534.89 | 631.37 | 625.60 | 655.34 | 556.24 | | |
| | | PhycoTerra | 0.30% | 486.05 | 489.93 | 666.71 | 667.64 | 649.71 | 542.56 | | |
| | | PhycoTerra | 3% | 486.05 | 532.46 | 678.09 | 679.15 | 671.50 | 581.39 | | |
| | | HS399WB | 0.03% | 486.05 | 500.14 | 533.44 | 652.87 | 704.72 | 564.30 | | |
| | | HS399WB | 0.30% | 486.05 | 498.44 | 640.95 | 667.39 | 725.19 | 555.75 | | |
| | | HS399WB | 3% | 486.05 | 524.68 | 683.48 | 680.40 | 717.11 | 598.24 | | |
| | Run 2 | standard practice | | 486.05 | 380.29 | 334.17 | 650.49 | 635.26 | 503.93 | | |
| | | seaweed | 1% | 486.05 | 508.86 | 627.95 | 670.75 | 657.95 | 629.51 | | |
| | | commercial ref. | | | | | | | | | |
| | | PhycoTerra | 0.03% | 486.05 | 505.20 | 577.04 | 648.58 | 660.17 | 641.26 | | |
| | | PhycoTerra | 0.30% | 486.05 | 506.66 | 683.25 | 691.01 | 671.51 | 644.39 | | |
| | | PhycoTerra | 3% | 486.05 | 509.59 | 662.78 | 693.42 | 674.72 | 678.58 | | |
| | | HS399WB | 0.03% | 486.05 | 426.81 | 603.34 | 697.28 | 664.86 | 639.17 | | |
| | | HS399WB | 0.30% | 486.05 | 493.48 | 644.27 | 714.65 | 671.27 | 669.45 | | |
| | | HS399WB | 3% | 486.05 | 508.86 | 631.36 | 709.58 | 679.40 | 693.20 | | |
| | Run 3 | standard practice | | 589.00 | 589.41 | 561.72 | | 533.76 | | 515.68 | 352.44 |
| | | seaweed | 1% | 589.00 | 627.51 | 633.19 | | 587.49 | | 415.83 | 425.99 |
| | | commercial ref. | | | | | | | | | |
| | | PhycoTerra | 0.30% | 589.00 | 599.80 | 610.97 | | 632.19 | | 437.19 | 458.25 |
| | | PhycoTerra | 1.00% | 589.00 | 620.58 | 648.22 | | 637.23 | | 470.86 | 465.01 |
| | | PhycoTerra | 3% | 589.00 | 623.25 | 653.57 | | 680.36 | | 512.66 | 493.89 |
| | | HS399WB | 0.30% | 589.00 | 603.00 | 595.60 | | 640.30 | | 372.18 | 448.60 |
| | | HS399WB | 1.00% | 589.00 | 620.05 | 629.13 | | 698.09 | | 389.13 | 460.05 |
| | | HS399WB | 3% | 589.00 | 634.97 | 672.43 | | 715.33 | | 443.00 | 490.28 |

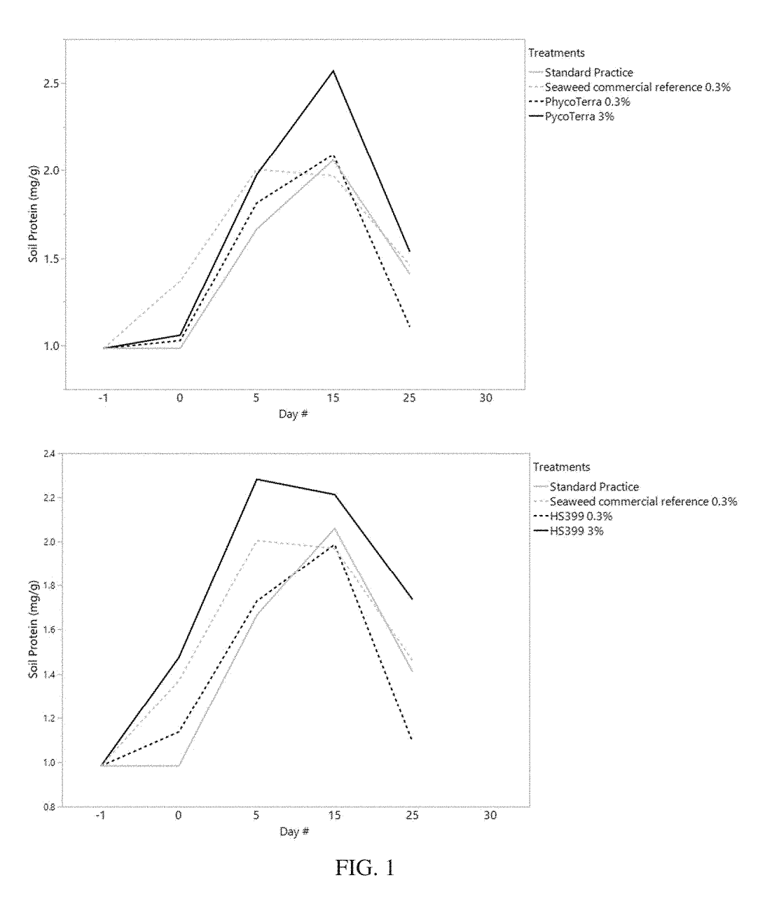

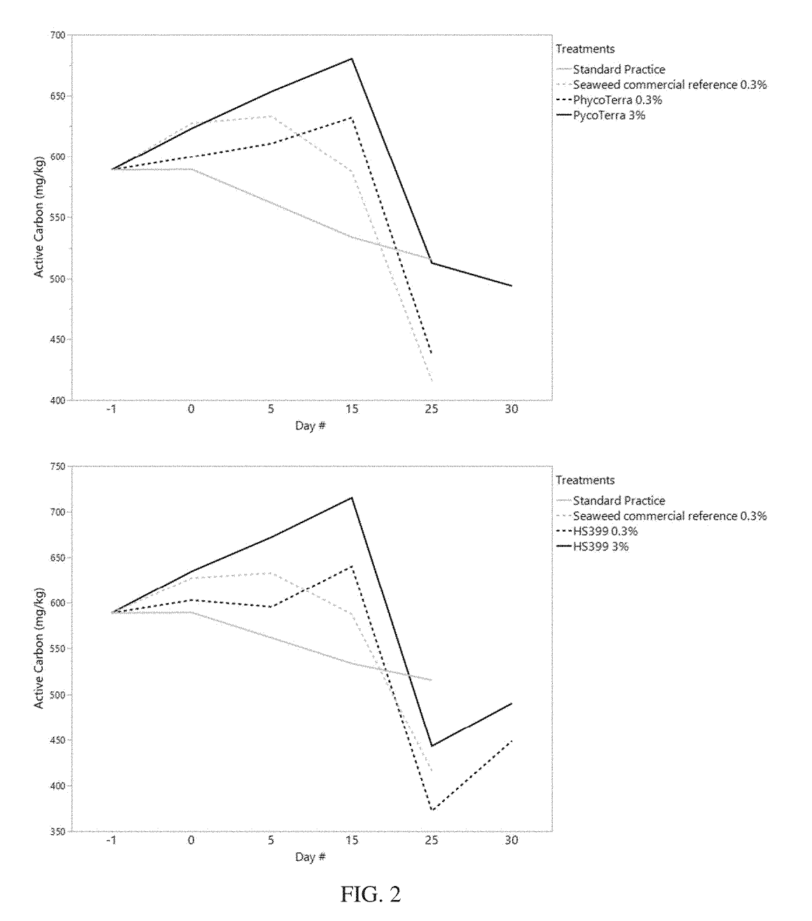

This set of efficacy experiments was designed to evaluate the various concentrations of the microalgal compositions and their effects on soil health after a single application. The results indicated that the microalgae compositions increased the concentration of soil active carbon and soil protein content in tested samples starting 5 days after application and reached optimal strength 15 days post application (see FIGS. 1-2). FIG. 1 (top) shows trends for soil protein (mg/g) for soils treated with the PHYCOTERRA® Chlorella microalgae composition at 3% and 0.3% v/v solution and FIG. 1 (bottom) shows trends for soil protein (mg/g) for soils treated with the Aurantiochytrium acetophilum HS399 whole biomass (WB) at 3% and 0.3% v/v solution. Soil samples treated with the PHYCOTERRA® Chlorella microalgae composition and with the Aurantiochytrium acetophilum HS399 whole biomass (WB) microalgae composition were observed to have higher soil protein levels than standard practice starting 5 days after application. FIG. 2 (top) shows trends for active carbon (mg/kg) for soils treated with the PHYCOTERRA® Chlorella microalgae composition at 3% and 0.3% v/v solution and FIG. 2 (bottom) shows the trends for active carbon (mg/kg) for soils treated with the Aurantiochytrium acetophilum HS399 whole biomass (WB) at 3% and 0.3% v/v solution. Soil samples treated with the PHYCOTERRA® Chlorella microalgae composition and with the Aurantiochytrium acetophilum HS399 whole biomass (WB) microalgae composition were observed to have higher active carbon levels than standard practice starting 5 days after application.

TABLE 3
Raw Data for Soil Aggregate

| Tests | Runs # | Treatments | Rates (v/v) | Day initial | Day 0 | Day 5 | Day 10 | Day 15 | Day 20 | Day 25 | Day 30 |
|---|---|---|---|---|---|---|---|---|---|---|---|
| Soil | Run 3 | standard practice | | 0.279 | 0.179 | 0.197 | | 0.412 | | 0.469 | |
| Aggregation | | seaweed | 0.30% | 0.279 | 0.218 | 0.135 | | 0.407 | | 0.479 | |
| (>1 mm | | commercial ref. | | | | | | | | | |
| PMR) | | PhycoTerra | 0.35 | 0.279 | 0.176 | 0.098 | | 0.352 | | 0.518 | |
| | | PhycoTerra | 3% | 0.279 | 0.175 | 0.076 | | 0.49 | | 0.486 | |
| | | HS399WB | 0.30% | 0.279 | 0.158 | 0.135 | | 0.374 | | 0.501 | |
| | | HS399WB | 3% | 0.279 | 0.173 | 0.126 | | 0.453 | | 0.544 | |

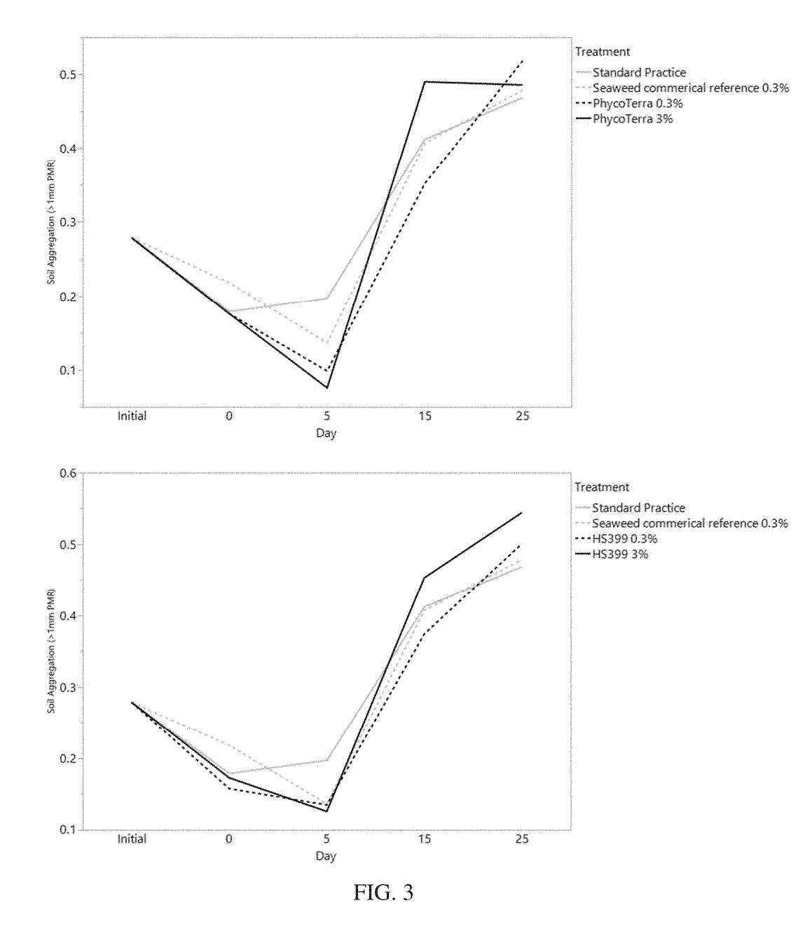

Soils treated with the microalgae compositions were also associated with higher levels of aggregation (see FIG. 3). In FIG. 3, soil aggregate diameters greater than 1 mm were used as an indicator for accumulation of larger aggregates in soil samples. FIG. 3 (top) shows the trends for soil aggregate for soils treated with the PHYCOTERRA® Chlorella microalgae composition at 3% and 0.3% v/v solution and FIG. 3 (bottom) shows the trends for soil aggregate for soils treated with the Aurantiochytrium acetophilum HS399 whole biomass (WB) at 3% and 0.3% v/v solution. Soil samples treated with the PHYCOTERRA® Chlorella microalgae composition and with the Aurantiochytrium acetophilum HS399 whole biomass (WB) microalgae composition indicated an increase in desired sizes of soil aggregates. Both the 3% PHYCOTERRA® Chlorella microalgae composition and the 3% Aurantiochytrium acetophilum HS399 whole biomass (WB) showed twice the amount of soil aggregation, as compared to the UTC, on day 15.

### Example 2

A trial was conducted to evaluate the effect of multiple applications of the PHYCOTERRA® Chlorella microalgae composition, the OMRI certified TERRENE® Chlorella microalgae composition, and the Aurantiochytrium acetophilum HS399 whole biomass (WB) microalgae composition on soil health. This trial was conducted and incorporated a bi-weekly application of the microalgae compositions. A total of two runs were completed; Run 1 took place Jun. 12, 2017-Jul. 24, 2017 and Run 2 took place Aug. 10, 2017-Oct. 4, 2017.

Arizona field soil (Antho sandy loam) was mixed with Sunshine Mix #4 at a 60:40 ratio v/v respectively. This mixture was then mixed further with 30% v/v perlite. 2.2 L aliquots of final mix were combined with product at various dilutions. 3 L of soil is mixed with 1000 mL of treatment solution and thoroughly mixed together to create the 3% v/v treatment application and the resulting treated soil was potted into 3 replicate quart pots. A sample of the final mix before treatment was obtained and samples of each quart pot were obtained. Quart pots were surrounded by a buffer layer of pots filled with sunshine mix. The microalgae composition treatments were administered in three bi-weekly applications. All collected samples were subjected to soil health analysis including soil active carbon, soil protein, total soil water holding capacity, aggregate size distribution, and total suspended solids. Raw data for soil protein (Table 4), active carbon (Table 5), soil water holding capacity (Table 6) and soil aggregate >1 mm PMR (Table 7), and total suspended solids (ppm) (Table 8) are shown in the Tables below.

TABLE 4
Raw Data for Soil Protein

| Tests | Run # | Treatments | Rates (v/v) | Intial | Day 0 | Day 15 | Day 30 | Day 45 | Day 60 |
|---|---|---|---|---|---|---|---|---|---|
| Soil | Run 1 | standard practice | | 3.82 | 3.89 | 4.02 | 5.70 | 5.84 | |
| Protein | | seaweed commercial | 0.30% | 3.82 | 4.25 | 3.34 | 6.13 | 6.27 | |
| (mg/g) | | reference | | 3.82 | 4.43 | 4.34 | 7.95 | 8.18 | |
| | | PhycoTerra | 3% | 3.82 | 3.75 | 4.28 | 6.90 | 7.41 | |
| | | HS399WB | 3% | 3.82 | 4.42 | 4.61 | 6.75 | 6.94 | |
| | Run 2 | standard practice | | 2.22 | 2.38 | 1.94 | 4.49 | 5.69 | 7.39 |
| | | seaweed commercial | 1% | 2.22 | 2.60 | 1.29 | 4.34 | 5.10 | 7.31 |
| | | reference | | | | | | | |
| | | Terrene | 1% | 2.22 | 2.82 | 3.08 | 6.07 | 7.09 | 11.39 |
| | | PhycoTerra | 1% | 2.22 | 3.66 | 3.05 | 4.90 | 6.26 | 8.52 |

TABLE 5
Raw Data for Active Carbon

| Tests | Run # | Treatments | Rates | Intial | Day 0 | Day 15 | Day 30 | Day 45 | Day 60 |
|---|---|---|---|---|---|---|---|---|---|
| Active | Run 1 | standard practice | | 538.17 | 575.91 | 635.40 | 594.80 | 580.01 | |
| Carbon | | seaweed commercial | 0.30% | 538.17 | 542.71 | 517.61 | 603.54 | 552.64 | |
| (mg/kg) | | reference | | | | | | | |
| | | Terrene | 3% | 533.17 | 625.07 | 620.75 | 835.04 | 734.92 | |
| | | PhycoTerra | 3% | 538.17 | 687.67 | 647.02 | 861.44 | 708.48 | |
| | | HS999WB | 3% | 538.17 | 689.45 | 753.25 | 768.32 | 675.35 | |
| | Run 2 | standard practice | | 433.33 | 538.55 | 500.35 | 621.33 | 638.34 | 542.95 |
| | | seaweed commercial | 1% | 433.33 | 516.49 | 347.14 | 594.92 | 610.00 | 525.94 |
| | | reference | | | | | | | |
| | | Terrene | 1% | 433.33 | 604.49 | 631.61 | 686.90 | 701.96 | 627.09 |
| | | PhycoTerra | 1% | 433.33 | 653.25 | 643.10 | 668.10 | 683.43 | 570.39 |

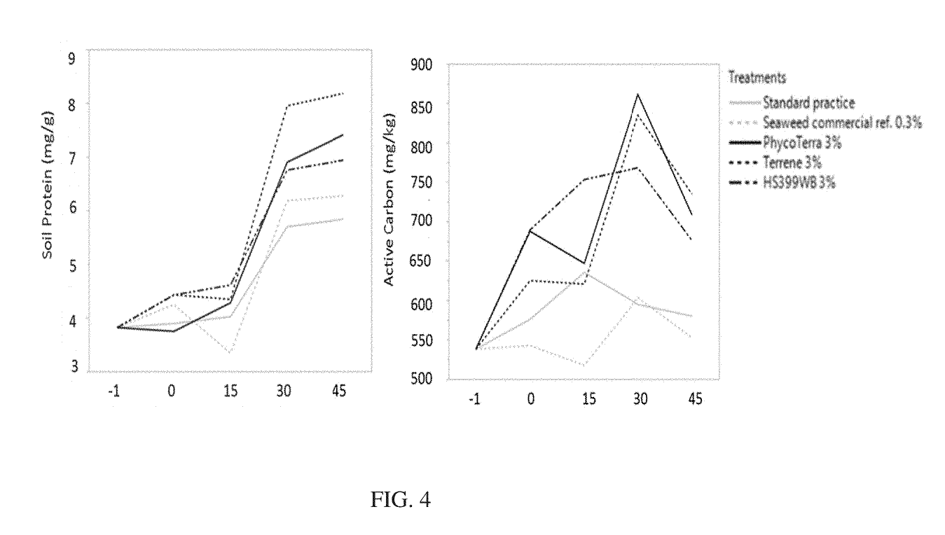

To validate findings from the previous experiments and to test the hypothesis of stepwise effects with multiple applications of the microalgae compositions, this set of experiments was conducted that incorporated three bi-weekly applications of the microalgae compositions. FIG. 4 shows the soil protein and active carbon trends for soils treated with the Aurantiochytrium acetophilum HS399 whole biomass (WB) microalgae composition, the PHYCOTERRA® Chlorella microalgae composition, and the OMRI certified TERRENE® Chlorella microalgae composition at 3% v/v solution with multiple applications. Both soil protein and active carbon levels for soils treated with the Aurantiochytrium acetophilum HS399 whole biomass (WB) microalgae composition, the PHYCOTERRA® Chlorella microalgae composition, and the OMRI certified TERRENE® Chlorella microalgae composition at 3% v/v solution were observed to reach their optimal strength 15 days after the first product application, with a positive stepwise trend after subsequent treatments as shown in FIG. 4. With three bi-weekly applications, the product-treated soil protein levels were increased by 40% with the OMRI certified TERRENE® Chlorella microalgae composition, by 27% with the PHYCOTERRA® Chlorella microalgae composition, and by 19% with the Aurantiochytrium acetophilum HS399 whole biomass (WB) microalgae composition compared to standard practices. In comparison with the seaweed commercial reference used in this trial, applying OMRI certified TERRENE® Chlorella microalgae composition yielded a ˜30% increase, the PHYCOTERRA® Chlorella microalgae composition increased 18%, while the Aurantiochytrium acetophilum HS399 whole biomass (WB) microalgae composition exhibited an 11% increase. This strongly suggests the microalgae compositions potentially influenced the buildup of organic-bound nitrogen sources inside the soil for future plant uptake.

Active carbon levels were increased by 27% by the OMRI certified TERRENE® Chlorella microalgae composition, by 22% by the PHYCOTERRA® Chlorella microalgae composition, and by 17% by the Aurantiochytrium acetophilum HS399 whole biomass (WB) microalgae composition compared to standard practice. Compared to the seaweed commercial reference, the OMRI certified TERRENE® Chlorella microalgae composition increased 33%, the PHYCOTERRA® Chlorella microalgae composition increased 28%, and the Aurantiochytrium acetophilum HS399 whole biomass (WB) microalgae composition increased 22%, with a positive stepwise trend. Both data sets indicate there was an increase in soil organic matter content with multiple applications of the microalgae compositions.

TABLE 6
Raw Data for Soil Water Holding Capacity

| Tests | Run # | Treatments | Rates (v/v) | Intial | Day 0 | Day 15 | Day 30 | Day 45 | Day 60 |
|---|---|---|---|---|---|---|---|---|---|
| Water | Run 1 | standard practice | | 70 | 70 | 66 | 60 | 65 | |
| holding | | seaweed commercial | 0.30% | 70 | 72 | 64 | 64 | 60 | |
| capacity | | reference | | | | | | | |
| % | | Terrene | 3% | 70 | 77 | 76 | 69 | 84 | |
| | | PhycoTerra | 3% | 70 | 67 | 74 | 81 | 94 | |
| | | HS399WB | 3% | 70 | 75 | 70 | 71 | 90 | |
| | Run 2 | standard practice | | 70 | 79 | 70 | 71 | 73 | 79 |
| | | seaweed commercial | 1% | 70 | 78 | 70 | 73 | 73 | 61 |
| | | reference | | | | | | | |
| | | Terrene | 1% | 70 | 80 | 80 | 81 | 96 | 98 |
| | | PhycoTerra | 1% | 70 | 79 | 79 | 77 | 83 | 86 |

TABLE 7
Raw Data for Soil Aggregation

| Tests | Run # | Treatments | Rates (v/v) | Intial | Day 0 | Day 15 | Day 30 | Day 45 | Day 60 |
|---|---|---|---|---|---|---|---|---|---|
| Aggregation | Run 1 | standard practice | | 0.19 | 0.34 | 0.61 | 0.53 | 0.29 | |
| size | | seaweed commercial | 0.30% | 0.19 | 0.49 | 0.64 | 0.66 | 0.34 | |
| >1 mm PMR | | reference | | | | | | | |
| | | Terrene | 3% | 0.19 | 0.62 | 0.56 | 0.72 | 0.39 | |
| | | PhycoTerra | 3% | 0.19 | 0.57 | 0.62 | 0.77 | 0.38 | |
| | | HS399WB | 3% | 0.19 | 0.55 | 0.69 | 0.68 | 0.39 | |

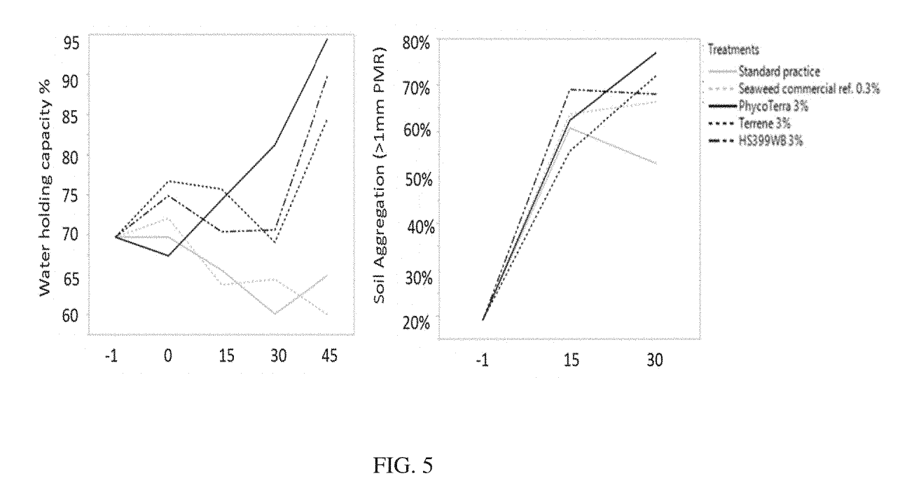

FIG. 5 shows the soil water holding capacity and aggregation trendlines for soils treated with the Aurantiochytrium acetophilum HS399 whole biomass (WB) microalgae composition, the PHYCOTERRA® Chlorella microalgae composition, and the OMRI certified TERRENE® Chlorella microalgae composition at 3% solution with multiple applications. As shown in FIG. 5, there exists a similar soil water holding capacity trend correlating with biological factors in treated soil, with an overall 30-45% increase over the course of three bi-weekly product applications. Data from the first trial indicates an increase in soil aggregation, but it remains unknown whether multiple applications of microalgae compositions sustain levels of aggregation. There is an average 35-37% increase in aggregation through this 45-day course (see FIG. 5) among the three microalgae compositions.

TABLE 8
Raw Data for Total Suspended Solids

| Tests | Run # | Treatments | Rates (v/v) | Intial | Day 0 | Day 15 | Day 30 | Day 45 | Day 60 |
|---|---|---|---|---|---|---|---|---|---|
| Total | Run 2 | standard practice | | | | 3464 | 7129 | 8673 | 26948 |
| suspended | | seaweed commercial | 1% | | | 4998 | 4741 | 7651 | 40981 |
| solids | | reference | | | | | | | |
| (ppm) | | Terrene | 1% | | | 2431 | 2155 | 749 | 2806 |
| | | PhycoTerra | 1% | | | 2289 | 3613 | 1897 | 6443 |

As shown in Table 8, the PHYCOTERRA® Chlorella microalgae composition at 1% and the OMRI certified TERRENE® Chlorella microalgae composition at 1% showed a decrease in total suspended solids. This indicates that the microalgae products decreased the amount of nutrient loss and soil loss in the runoff water, thereby leading to better runoff water quality.

### Example 3

A trial was conducted to evaluate the effect of the OMRI certified TERRENE® Chlorella microalgae composition, the Aurantiochytrium acetophilum HS399 whole biomass (WB) microalgae composition, and the Aurantiochytrium acetophilum HS399 extracted biomass (EB) microalgae composition on soil health as compared to a seaweed commercial reference and a bacterial commercial reference. This trial incorporated a single application of the microalgae compositions.

Arizona field soil (Antho sandy loam) was mixed with Sunshine Mix #4 at a 60:40 ratio v/v respectively. This mixture was then mixed further with 30% v/v perlite. 2.2 L aliquots of final mix were combined with product at various dilutions. 3 L of soil is mixed with 1000 mL of treatment solution and thoroughly mixed together to create the 3% v/v treatment application and the resulting treated soil was potted into 3 replicate quart pots. A sample of the final mix before treatment was obtained and samples of each quart pot were obtained. Quart pots were surrounded by a buffer layer of pots filled with sunshine mix. The single application of the test subjects was applied at the beginning of the trial and the application rates were adapted from the product directions. Samples were subjected to collect at initial, day 0, 5, 10, 15, and 20. In addition to the aforementioned assays, a water holding capacity assay based on the Keen-Rackzowski box method (Viji. et al 2012) was established. Soil aggregation data was not collected, as this experiment was not run past 20 days. Previous data suggests soil aggregation differences are detected by Day 30. All collected samples were subjected to soil health analysis including soil active carbon, soil protein, total soil water holding capacity, and aggregate size distribution. Raw data for soil protein (Table 9), active carbon (Table 10), soil water holding capacity (Table 11) and soil aggregate >1 mm PMR (Table 12) are shown in the Tables below.

TABLE 9
Raw Data for Soil Protein

| Tests | Treatments | Rates (v/v) | Initial | Day 5 | Day 10 | Day 15 | Day 20 |
|---|---|---|---|---|---|---|---|
| Soil | Standard practice | | 2.27 | 3.04 | 2.63 | 1.85 | 1.84 |
| Protein | seaweed commerical reference | 1% | 2.27 | 2.59 | 1.85 | 1.57 | 1.69 |
| (mg/g) | Terrene | 1% | 2.27 | 2.93 | 3.05 | 2.55 | 2.33 |
| | HS399WB | 1% | 2.27 | 3.09 | 3.13 | 2.47 | 2.78 |
| | HS399EB | 1% | 2.27 | 3.56 | 3.69 | 3.24 | 2.88 |
| | Bacterial commercial reference a | 1% | 2.27 | 3.85 | 3.34 | 2.98 | 2.47 |
| | Bacterial commercial reference a | 3% | 2.27 | 3.77 | 2.92 | 1.89 | 2.45 |
| | Bacterial commercial reference b | 1% | 2.27 | 2.76 | 3.08 | 1.99 | 2.70 |
| | Bacterial commercial reference c | 1% | 2.27 | 4.18 | 3.08 | 2.45 | 2.31 |
| | Bacterial commercial reference d | 1% | 2.27 | 4.30 | 2.99 | 2.18 | 2.09 |

TABLE 10
Raw Data for Active Carbon

| Tests | Treatments | Rates (v/v) | Initial | Day 5 | Day 10 | Day 15 | Day 20 |
|---|---|---|---|---|---|---|---|
| Active | Standard practice | | 645.62 | 648.82 | 624.60 | 408.23 | 370.58 |
| Carbon | seaweed commerical reference | 1% | 645.62 | 653.26 | 563.05 | 320.11 | 390.60 |
| (mg/kg) | Terrene | 1% | 645.62 | 708.50 | 712.94 | 714.85 | 646.20 |
| | HS399WB | 1% | 645.62 | 678.41 | 701.65 | 697.89 | 684.68 |
| | HS399EB | 1% | 645.62 | 663.12 | 675.70 | 678.07 | 687.38 |
| | Bacterial commercial reference a | 1% | 645.62 | 670.28 | 585.42 | 576.58 | 538.20 |
| | Bacterial commercial reference a | 3% | 645.62 | 646.85 | 557.96 | 534.79 | 555.30 |
| | Bacterial commercial reference b | 1% | 645.62 | 656.71 | 608.87 | 564.17 | 520.65 |
| | Bacterial commercial reference c | 1% | 645.62 | 649.56 | 585.19 | 548.17 | 533.70 |
| | Bacterial commercial reference d | 1% | 645.62 | 694.20 | 689.03 | 614.79 | 531.23 |

TABLE 11
Raw Data for Soil Water Holding Capacity

| Tests | Treatments | Rates (v/v) | Initial | Day 5 | Day 10 | Day 15 | Day 20 |
|---|---|---|---|---|---|---|---|
| Water | Standard practice | | 62 | 60 | 52 | 52 | 58 |
| holding | seaweed commerical reference | 1% | 62 | 62 | 55 | 52 | 58 |
| capacity | Terrene | 1% | 62 | 65 | 75 | 74 | 75 |
| % | HS399WB | 1% | 62 | 54 | 73 | 75 | 74 |
| | HS399EB | 1% | 62 | 63 | 63 | 60 | 71 |
| | Bacterial commercial reference a | 1% | 62 | 61 | 61 | 64 | 69 |
| | Bacterial commercial reference a | 3% | 62 | 64 | 59 | 58 | 59 |
| | Bacterial commercial reference b | 1% | 62 | 60 | 54 | 54 | 61 |
| | Bacterial commercial reference c | 1% | 62 | 60 | 57 | 61 | 66 |
| | Bacterial commercial reference d | 1% | 62 | 63 | 65 | 66 | 66 |

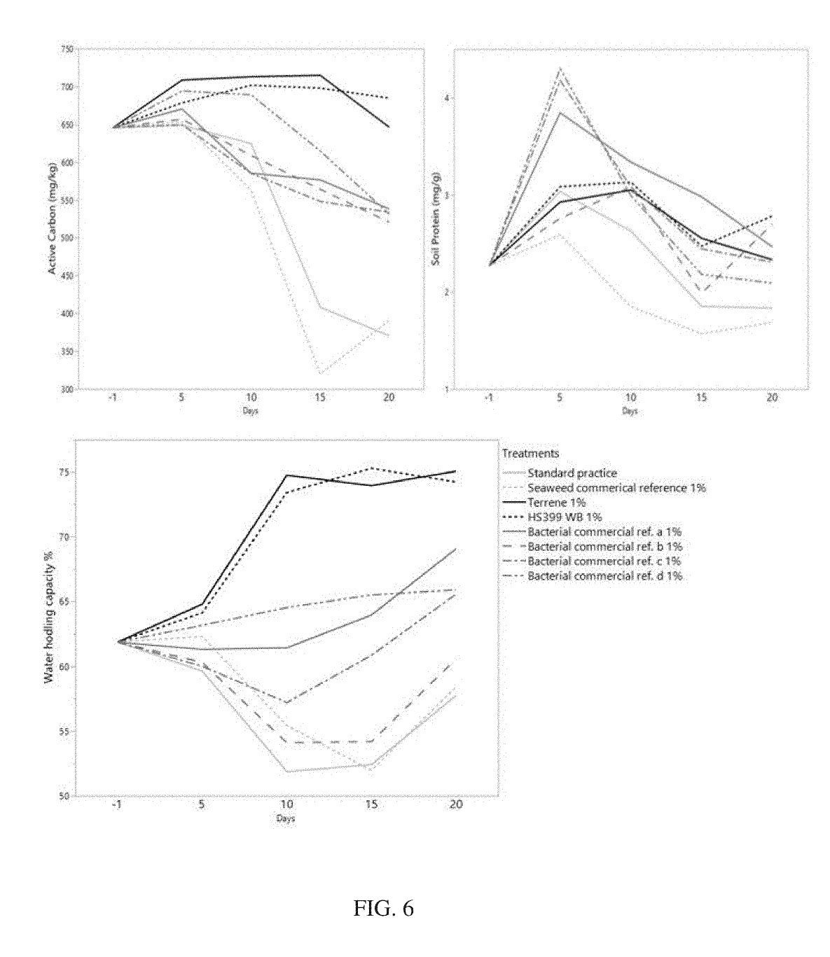

To confirm the findings, the effect of the microalgal compositions were compared to four commercialized bacterial products with similar soil health claims, as shown in FIG. 6. FIG. 6 shows the soil protein (top right), active carbon (top left), and soil water holding capacity (bottom) trend lines for a 20-day course study. The soil was treated with a single application of the Aurantiochytrium acetophilum HS399 whole biomass (WB) microalgae composition, the OMRI certified TERRENE® Chlorella microalgae composition, seaweed commercial reference, and “a-d” four commercialized bacterial products at 1% v/v. Bacterial commercialized product application rates were around 1% according to manufacturer instructions. Bacterial commercial references 3 and 4 show a substantial increase on Day 5 but are extremely unsteady compared to the microalgal product. Overall, the organic Aurantiochytrium acetophilum HS399 extracted biomass (EB) microalgae composition generated 57% more soil protein compared to standard practice, nearly 70% more soil protein as compared to seaweed commercial reference, and showed a 20% average increase in soil protein comparison to the bacterial commercial references.

A similar pattern regarding active carbon behavior was observed in soil samples treated with the Aurantiochytrium acetophilum HS399 whole biomass (WB) microalgae composition, the OMRI certified TERRENE® Chlorella microalgae composition, and the organic Aurantiochytrium acetophilum HS399 extracted biomass (EB) microalgae composition. The active carbon level generated from these three treatments reached a maximum around Day 15 and was maintained by further applications. By contrast, the commercialized product decreased in active carbon after 5 days. FIG. 6 also shows the water holding capacity trend. It is obvious that the Aurantiochytrium acetophilum HS399 whole biomass (WB) microalgae composition and the OMRI certified TERRENE® Chlorella microalgae composition improved water holding ability by 27-30% when compared to the commercialized products.

TABLE 12
Raw Data for Soil Aggregation

| Tests | Treatments | Rates (v/v) | Initial | Day 5 | Day 10 | Day 15 | Day2 |
|---|---|---|---|---|---|---|---|
| Aggregation | Standard practice | | 0.36 | | | 0.60 | 0.49 |
| >1 mm PMR | seaweed commerical reference | 1% | 0.36 | | | 0.57 | 0.53 |
| | Terrene | 1% | 0.36 | | | 0.58 | 0.52 |
| | HS399WB | 1% | 0.36 | | | 0.63 | 0.52 |
| | HS399EB | | | | | | |
| | Bacterial commercial reference a | 1% | 0.36 | | | 0.56 | 0.55 |
| | Bacterial commercial reference a | 3% | 0.36 | | | 0.60 | 0.55 |
| | Bacterial commercial reference b | 1% | 0.36 | | | 0.63 | 0.41 |
| | Bacterial commercial reference c | 1% | 0.36 | | | 0.59 | 0.52 |
| | Bacterial commercial reference d | 1% | 0.36 | | | 0.63 | 0.56 |

Besides conducting experiments with in-house soil blends, 21 USDA-NCRS categorized soil types were tested by soil health arrays after they were treated with the microalgal compositions. They have been classified further as coarse-textured (sand, loamy sand, sandy loam), medium-textured (loam, silt loam, silt, sandy clay loam) or fine-textured (silty clay loam, silty clay, and clay) soils (see Table 13 below). There is a clear indication that the microalgal product takes 14-15 days to release and reach its optimal strength after each application. The statistics and percentage increases in soil health factors vary among different soil types, yet similar patterns were consistently observed with regards to soil health.

TABLE 13
Various Soil Types and Origins

| Crops | Trial | County | Soil Type |
|---|---|---|---|
| Alfalfa | RDT2531 | Maricopa, AZ | Antho Sandy loam |
| Bell | Stress | Yuma, AZ | Holtville sandy loam |
| pepper | conditions | | and kofa clay |
| Strawberry | Guadalupe | Santa Barbara, CA | Metz loamy sand |
| Strawberry | Santa Maria | Santa Barbara, CA | Corralito sandy loam |
| Strawberry | Oxnard | Ventura, CA | Cropley Clay |
| Strawberry | Fresno | Fresno, CA | San Joaquin sandy |
| | | | loam, shallow |
| Strawberry | Salinas | Monterey, CA | Salinas clay loam |
| Strawberry | Aromas/Royal | Santa Cruz, CA | Elkhorn loamy fine |
| | Oak | | sand |
| Strawberry | Watsonville | Santa Cruz, CA | Elder Sandy clay |
| | | | loam |
| Lettuce | Duncan | Maricopa, AZ | Valencia Sandy loam |
| Unknown | National soil | Travis, TX | Houston Black clay |
| | map experiment | | |
| Unknown | National soil | Rapides Parish, | Frost silt loam |
| | map experiment | LA | |
| Unknown | National soil | Mobile, AL | Heidel sandy loam |
| | map experiment | | |
| Unknown | National soil | Tift, GA | Alapaha loamy sand |
| | map experiment | | |
| Unknown | National soil | Lake, FL | Hurricane fine sand |
| | map experiment | | |
| Unknown | National soil | Beaufort, SC | Willman loamy fine |
| | map experiment | | sand |
| Unknown | National soil | Franklin, NC | Cecil sandy loam |
| | map experiment | | |
| Unknown | National soil | Cannon, TN | Dickson silt loam |
| | map experiment | | |
| Unknown | National soil | Caldwell, KY | Hammack-Baxter |
| | map experiment | | silty clay loam |
| Unknown | National soil | Tate, MI | Dundee loam |
| | map experiment | | |
| Unknown | National soil | Lonoke, AK | Calloway silt loam |
| | map experiment | | |
| Unknown | National soil | Grandy, OK | Renfrow silt loam |
| | map experiment | | |
| Unknown | National soil | Cibola, NM | Mespun loamy fine |
| | map experiment | | sand |
| Unknown | National soil | Coconino, AZ | Tuba-Tyende |
| | map experiment | | complex |

### Example 4

A trial was conducted in Yuma, Ariz. on bell peppers. The primary goal of this Yuma Bell Pepper Trial was to evaluate the benefit of the PHYCOTERRA® Chlorella microalgae composition, the Aurantiochytrium acetophilum HS399 whole biomass (WB) microalgae composition, and the Aurantiochytrium acetophilum HS399 extracted biomass (EB) microalgae composition on pepper growth and yield when stress conditions were present. Soil health analysis was completed on soil collected at final harvest to determine the product's effect on soil quality under stress conditions.

The field trial was set up as a split plot with randomized treatments within each split. The land was a combination of Holtville sandy loam and Kofa clay. Bell pepper plants were transplanted to the field in early April of 2017, according to local commercial practice. There was a total of 4 treatments per split plot block: an untreated control (without any microalgae composition) and the three microalgae compositions (i.e. PHYCOTERRA® Chlorella microalgae composition, the Aurantiochytrium acetophilum HS399 whole biomass (WB) microalgae composition, and the Aurantiochytrium acetophilum HS399 extracted biomass (EB) microalgae composition) either at 0.5 gal/acre or 1 gal/acre. Blocks were set up for either intensive management, irrigation stress, or reduced fertility. The first application of microalgae composition occurred at the time of transplant using a dip method on the transplant roots and then reapplication of the microalgae composition occurred every 21 days afterward until harvest via drip irrigation. Initial and final soil samples were collected and subjected to soil health analysis. Soil samples were insufficient for soil aggregation testing; therefore, this test was omitted in this trial. Raw data is shown in Table 14 below.

TABLE 14
Raw Data

| | | Water holding |
|---|---|---|
| Treatment | Stress conditions | capacity % |
| standard practice | intensive management | 14.8 |
| standard practice | 70% irrigation | 17.4 |
| standard practice | 70% fertilization | 14.2 |
| Seaweed commercial ref. | intensive management | 31.6 |
| Seaweed commercial ref. | 70% irrigation | 32.9 |
| Seaweed commercial ref. | 70% fertilization | 34.2 |
| PhycoTerra | intensive management | 38.4 |
| PhycoTerra | 70% irrigation | 42.4 |
| PhycoTerra | 70% fertilization | 37.8 |
| HS399WB | intensive management | 32.8 |
| HS399WB | 70% irrigation | 35.0 |
| HS399WB | 70% fertilization | 34.0 |
| HS399 EB | intensive management | 36.8 |
| HS399 EB | 70% irrigation | 40.7 |
| HS399 EB | 70% fertilization | 35.8 |

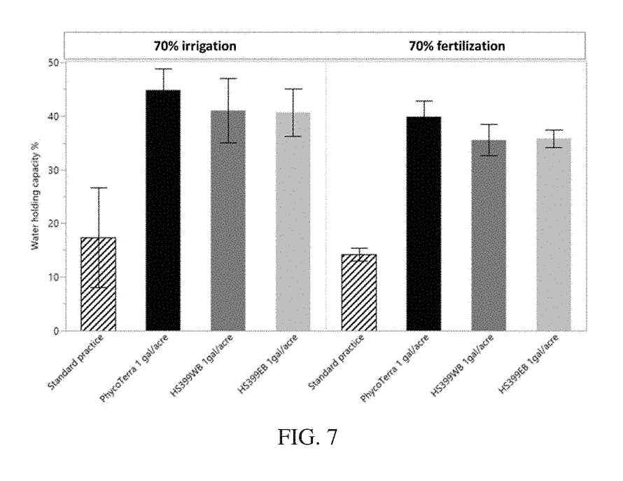

This field trial was used to test soil responses to the microalgae compositions under stress conditions. Although 30% reductions in water and fertilizer were applied to mimic stress conditions, the soil health response patterns were similar to those observed in previous studies, particularly with respect to water holding capacity. The soil treated with the microalgae compositions increased almost 20% point-to-point water holding capacity under limited irrigation conditions. FIG. 7 is a graph showing a water holding capacity % histogram at stress conditions.

### Example 5

A direct field level trial in an actively managed alfalfa field to was conducted in Gilbert, Ariz. to expand and validate the findings from the lab. The field trial aimed to test the effect of monthly applications of the microalgae compositions on the soil health of this field, as well as crop yield.

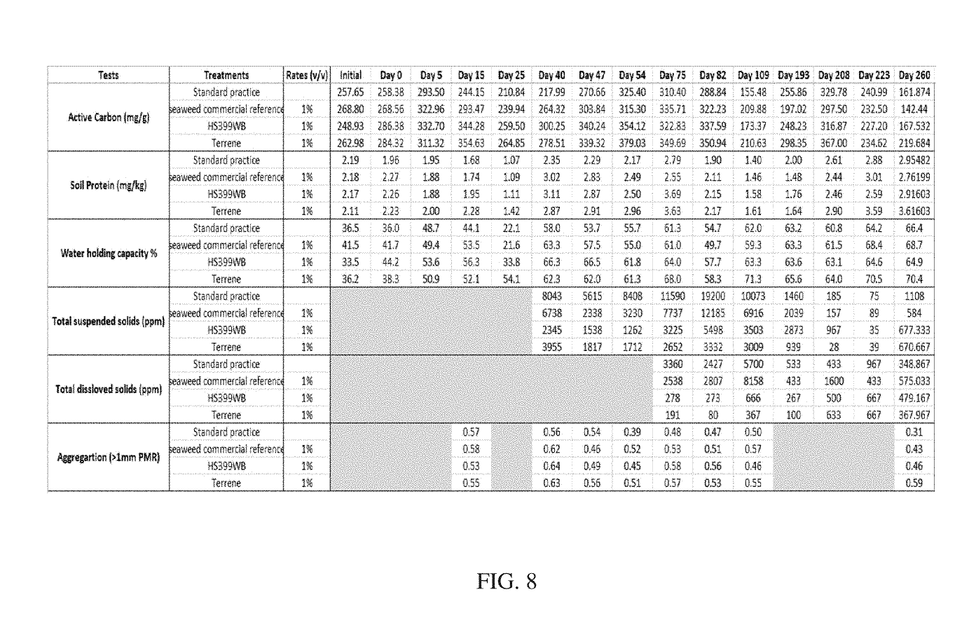

The test plots were Antho sandy loam. The plots were marked on berms with flags and compass bearings and the distance was measured to ensure correct sampling placement. Hoses from barrels were run out to test plots and attached to an H-manifold sprayer. Barrels were emptied with use of a pump and products were applied as evenly as possible over 40 sq. ft. plots. Soil cores were taken from plots prior to application. Since flooding irrigation was employed in the field, each plot received on average 25 gallons of microalgae composition treatments at the stated concentrations from four 55-gallon drums. Soil samples were collected and subjected to soil health analysis accordingly. Six applications were applied, and monitoring continued thru summer 2018. Raw data for active carbon, soil protein, water holding capacity, total suspended solids, total dissolved solids, and soil aggregation is shown in FIG. 8.

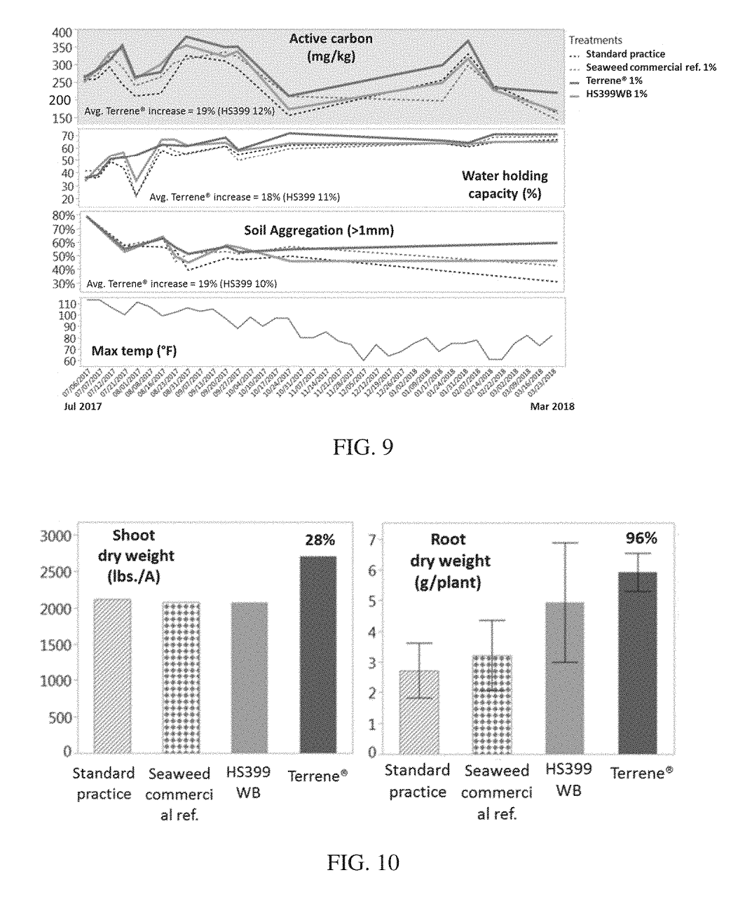

The Gilbert field trial, which was evaluated beginning July 2017, involved a total of 6 microalgae composition applications. During the 260-day monitoring course, the OMRI certified TERRENE® Chlorella microalgae composition increased active carbon in the soil an average of 19%, while the Aurantiochytrium acetophilum HS399 whole biomass (WB) microalgae composition generated an average increase of 12%. Total soil water holding capacity increased an average of 18% with the OMRI certified TERRENE® Chlorella microalgae composition and ˜11% with the Aurantiochytrium acetophilum HS399 whole biomass (WB) microalgae composition; soil aggregates (>1 mm PMR) increased ˜19% with the OMRI certified TERRENE® Chlorella microalgae composition, and 10% with the Aurantiochytrium acetophilum HS399 whole biomass (WB) microalgae composition. Considering the local climate, the OMRI certified TERRENE® Chlorella microalgae composition showed promise in extreme conditions (see FIG. 9) which corresponded with the data from Example 4 above. FIG. 9 shows active carbon, water holding capacity, and soil aggregation trends across 260 days of monitoring with climate changes. The dry biomass of plant shoot and roots harvested also confirmed the overall soil improvements with the microalga composition treatments (see FIG. 10). FIG. 10 shows a dry biomass comparison on harvested alfalfa shoots and roots. By applying 6 applications of the OMRI certified TERRENE® Chlorella microalgae composition at 1% v/v, there was a 28% increase in shoot dry biomass (lbs/acre) and a 96% increase in root biomass (g/plant).

Furthermore, during the 260-day monitoring course, the OMRI certified TERRENE® Chlorella microalgae composition increased soil protein in the soil an average of 21%, while the Aurantiochytrium acetophilum HS399 whole biomass (WB) microalgae composition generated an average increase of 12%. Total suspended solids and total dissolved solids were both significantly reduced to comply with the United States Environmental Protection Agency (EPA) water quality criteria of Fresh Water.

### Example 6

This field trial was conducted to evaluate the benefit of the OMRI certified TERRENE® Chlorella microalgae composition on Goodyear, Ariz. organic lettuce growth, yield, post-harvest lettuce quality, and soil quality.

Seven acres of Valencia sandy loam land were used in this trial. Lettuce plants were seeded to the field in January 2017, according to local commercial practice. The first application of the microalgae composition was administered via spray irrigation at the time of seeding at the application rates of 3 gal/acre (3% concentration) and 6 gal/acre (6%) concentration. The soil samples were collected at seeding and then collected again every 7 days afterward through the final harvest. The untreated control received the same amount of carrier water as other treatments at the time of product application. Raw data is shown in Table 15 below.

TABLE 15
Raw Data

| | | | Data | >1 mm PMR | Dry root |
|---|---|---|---|---|---|
| Day # | Lettuce type | Treatment | points | aggregation | biomass (g) |
| Final harvest | Red Romaine | standard | 3 | 22.84 | 0.16 |
| | | practice | | | |
| Final harvest | Red Romaine | 3% | 3 | 29.07 | 0.19 |
| Final harvest | Red Romaine | 6% | 3 | 26.96 | 0.18 |

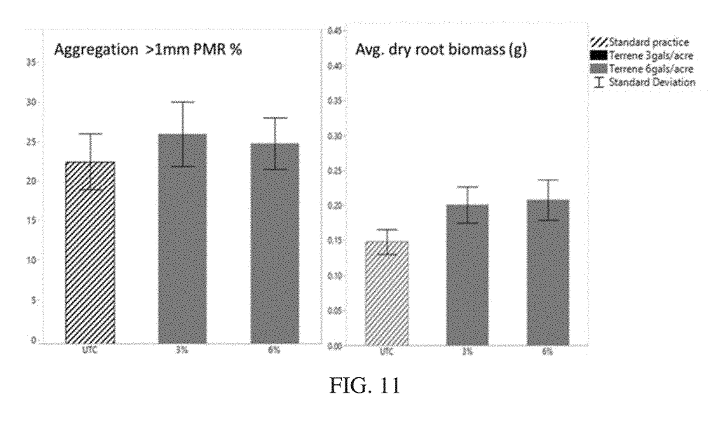

FIG. 11 is a graph showing aggregation and dry root biomass from soils treated with the OMRI certified TERRENE® Chlorella microalgae composition at 3 gal/acre and 6 gal/acre on organic red romaine lettuce at final harvest. The trial showed that the OMRI certified TERRENE® Chlorella microalgae composition has a positive impact on soil health and is not limited to improving soil aggregate formation, but also increased plant root biomass at final harvest. There was roughly a 33% increase in root biomass with a 13% increase in desired sizes of soil aggregates with treatments over a 45-day cycle.

### Example 7

A series of field trials were conducted to evaluate the benefit of several microalgae compositions on conventional and organic strawberry growth, yield, post-harvest berry quality, and soil quality.

Field Trial A was located at Guadalupe, Calif., which was comprised of Metz loamy sand. The purpose of the trial was to test the effects of the PHYCOTERRA® Chlorella microalgae composition, the Aurantiochytrium acetophilum HS399 washed whole biomass (WB) microalgae composition, the Aurantiochytrium acetophilum HS399 whole biomass (WB) microalgae composition, the OMRI certified TERRENE® Chlorella microalgae composition, and the combination 25% Chlorella: 75% HS399 whole biomass (WB) microalgae composition on soil. In addition to the microalgae compositions, all randomized plots received the standard local fertilization regimen used by the grower for this crop, excluding biostimulants. Strawberry plants were transplanted to the field in early June 2017, according to local commercial practice. The microalgae compositions were applied via drip irrigation at the time of transplanting, and then applied again every 14 days afterward until harvest. The untreated control received the same amount of carrier water as other treatments at the time of each application of the microalgae compositions. Soil samples (300 g triplicates) of the untreated control were collected before transplanting from root zone depth. Replicates from each treatment at final harvest (from root zone) were collected and tested for nutrient/microbiome analysis and soil health screening. Raw data for active carbon (Table 16), soil protein (Table 17), soil water holding capacity (Table 18), total dissolved solids (Table 19), and total suspended solids (Table 20) from Field Trial A in Guadalupe, Calif. are shown in Tables 16-20 below.

TABLE 16
Raw Data for Active Carbon (mg/g)

| Tests | Treatments | Rates(gals/acre) | Final harvest |
|---|---|---|---|
| Active | Full Fertility + Water | | 45.66 |
| Carbon | Seaweed commercial ref. | 0.5 | 64.05 |
| (mg/g) | PHYCOTERRA ® | 0.5 | 51.39 |
| | HS399 WB washed | 0.5 | 51.03 |
| | HS399 WB | 0.5 | 84.96 |
| | TERRENE ® | 0.5 | 99.50 |
| | 25:75 Chlorella/HS399WB | 0.5 | 90.75 |

TABLE 17
Raw Data for Soil Protein (mg/kg)

| Tests | Treatments | Rates(gal/acre) | Final harvest |
|---|---|---|---|
| Soil | Full Fertility + Water | | 1.56 |
| Protein | Seaweed commercial ref. | 0.5 | 1.47 |
| (mg/kg) | PHYCOTERRA ® | 0.5 | 1.68 |
| | HS399 WB washed | 0.5 | 1.67 |
| | HS399 WB | 0.5 | 1.71 |
| | TERRENE ® | 0.5 | 1.75 |
| | 25:75 Chlorella/HS399WB | 0.5 | 1.77 |

TABLE 18
Raw Data for Soil Water Holding Capacity (%)

| Tests | Treatments | Rates(gal/acre) | Final harvest |
|---|---|---|---|
| Water | Full Fertility + Water | | 42 |
| holding | Seaweed commercial ref. | 0.5 | 41 |
| capacity | PHYCOTERRA ® | 0.5 | 40 |
| % | HS399 WB washed | 0.5 | 38 |
| | HS399 WB | 0.5 | 41 |
| | TERRENE ® | 0.5 | 42 |
| | 25:75 Chlorella/HS399WB | 0.5 | 36 |

TABLE 19
Raw Data for Total Dissolved Solids (ppm)

| Tests | Treatments | Rates(gal/acre) | Final harvest |
|---|---|---|---|
| Total | Full Fertility + Water | | 900 |
| dissolved | Seaweed commercial ref. | 0.5 | 633 |
| solids | PHYCOTERRA ® | 0.5 | 1751 |
| (ppm) | HS399 WB washed | 0.5 | 651 |
| | HS399 WB | 0.5 | 1923 |
| | TERRENE ® | 0.5 | 2083 |
| | 25:75 Chlorella/HS399WB | 0.5 | 2536 |

TABLE 20
Raw Data for Total Dissolved Solids (ppm)

| Tests | Treatments | Rates(gal/acre) | Final harvest |
|---|---|---|---|
| Total | Full Fertility + Water | | 467 |
| suspended | Seaweed commercial ref. | 0.5 | 467 |
| solids | PHYCOTERRA ® | 0.5 | 467 |
| (ppm) | HS399 WB washed | 0.5 | 433 |
| | HS399 WB | 0.5 | 567 |
| | TERRENE ® | 0.5 | 500 |
| | 25:75 Chlorella/HS399WB | 0.5 | 300 |

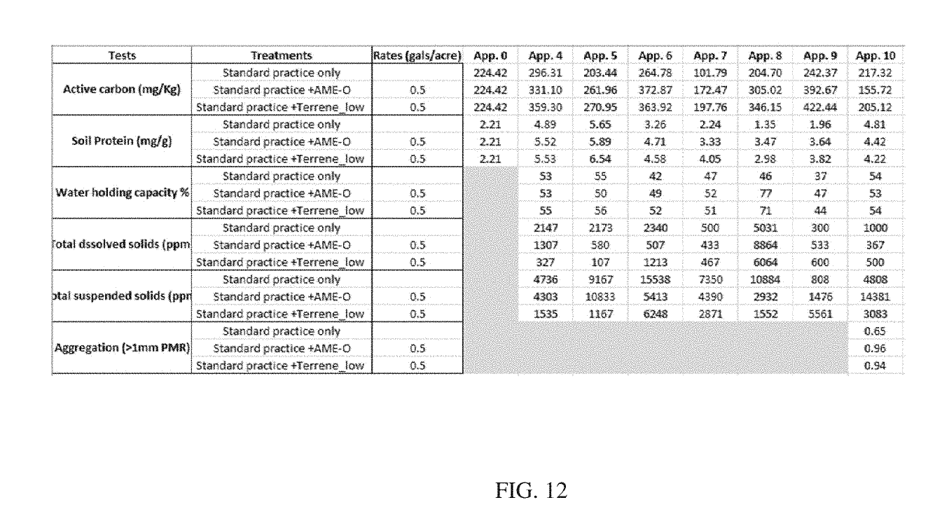

Field Trial B was conducted in Santa Maria, Calif. on Corralitos sandy loam (sand:silt:clay=74%:14%:12%). All plots (randomized) received standard local fertigation practice, including NEPTUNE'S HARVEST fertilizer and NFORCE fertilizer. A control was added with standard local fertigation practice plus 4 applications of an organic fertilizer commercial reference that were standard to this location. Treatments included the OMRI certified TERRENE® Chlorella pasteurized at 65° C. microalgae composition and the organic commercial reference product (AME-O) alone. Strawberry plants (frigo) were transplanted to the field in June 2017, according to local commercial practice. The microalgae compositions were initially applied via drip irrigation at the time of transplanting and then applied again every 14 days afterward through to final harvest. The untreated control received the same amount of carrier water as other treatments at the time of each microalgae composition application. Starting with the 4th application, soil samples were analyzed for soil health bi-weekly. Raw data is shown in FIG. 12.

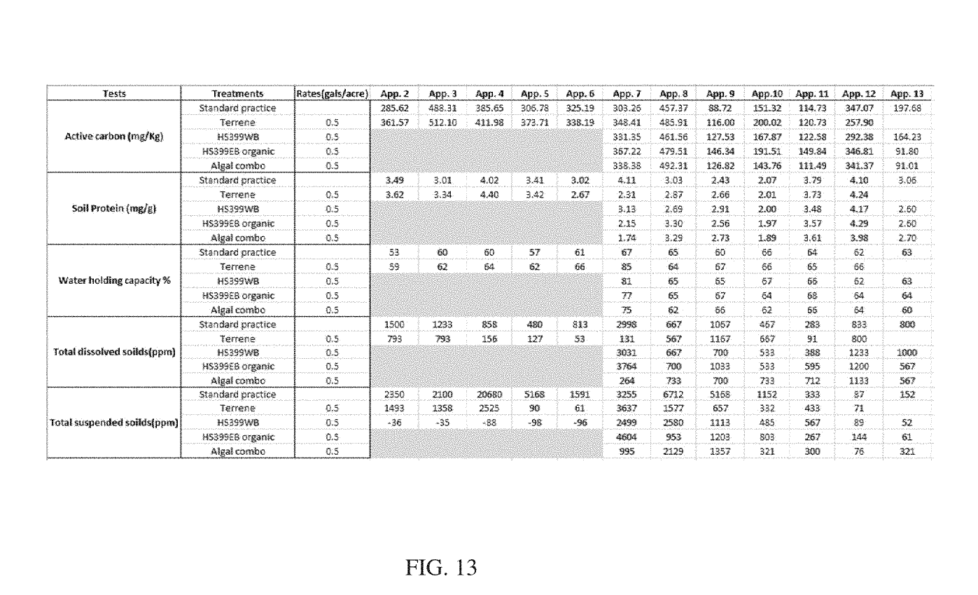

Field Trial C took place in Oxnard, Calif. (Cropley clay soil). This trial tested the effects of the OMRI certified TERRENE® Chlorella microalgae composition, the Aurantiochytrium acetophilum HS399 whole biomass (WB) microalgae composition, the organic Aurantiochytrium acetophilum HS399 extracted biomass (EB) microalgae composition, and the combination 25% Chlorella: 75% HS399 whole biomass (WB) microalgae composition on soil. Application methods were the same as described in the other field trials of this Example. In this trial, strawberry plants were transplanted to the field in July 2017, according to local commercial practice. Bi-weekly soil samples, along with initial and final soil samples, were subjected to nutrient/microbiome analysis. Raw data is shown in FIG. 13.

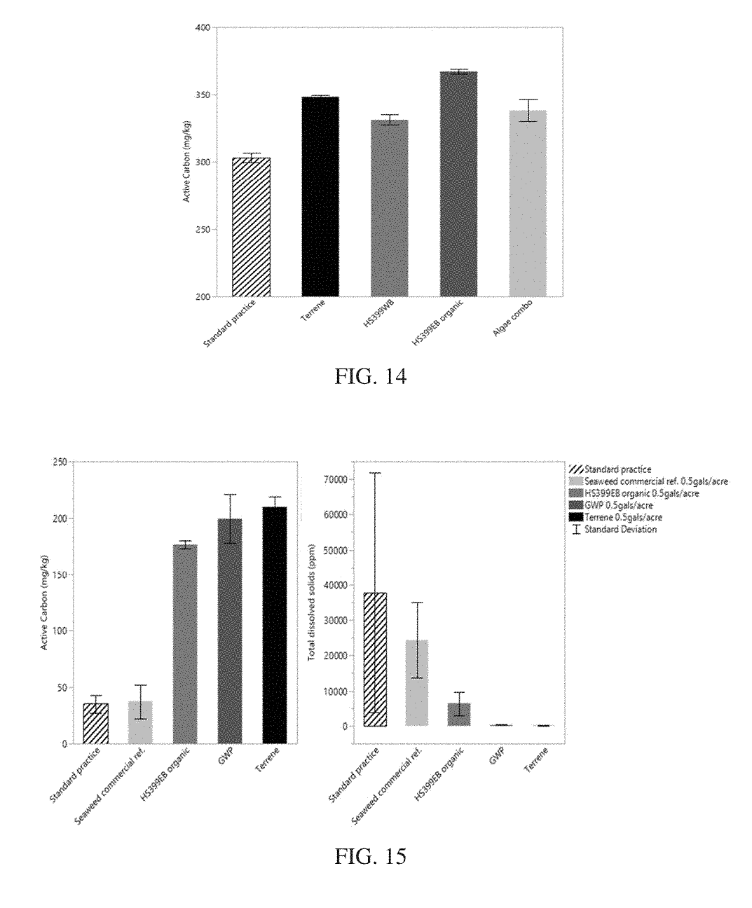

Clay soil often has problems with poor aeration and increased compaction compared to sandier soil. Because the soil particles are small and closely spaced, it is very difficult for air or nutrients to exchange inside the soil. However, active carbon levels in Field Trial C (Cropley clay) increased by 10-20% compared to standard practice after 7 applications of the OMRI certified TERRENE® Chlorella microalgae composition, the Aurantiochytrium acetophilum HS399 whole biomass (WB) microalgae composition, the organic Aurantiochytrium acetophilum HS399 extracted biomass (EB) microalgae composition, and the combination 25% Chlorella: 75% HS399 whole biomass (WB) microalgae composition at 0.5 gals/acre (see FIG. 14.) FIG. 14 is a graph that shows a comparison of the changes in active carbon levels in the soil after 7 applications of the microalgae compositions. Field trial data suggests that the microalgae compositions likely benefit diverse soil types.

Field Trial D was conducted in Fresno, Calif. (San Joaquin sandy loam). The purpose of the trial was to test the effects of the OMRI certified TERRENE® Chlorella microalgae composition, the organic Aurantiochytrium acetophilum HS399 extracted biomass (EB) microalgae composition, the Aurantiochytrium acetophilum HS399 whole biomass (WB) microalgae composition, the PHYCOTERRA® Chlorella microalgae composition, and the Greenwater Polyculture microalgae composition on soil. Application methods Ut supra. Strawberry plants were transplanted to the field in mid-August 2017, according to local commercial practice. Soil samples from root zone depth from 3 untreated control replicates were collected before transplanting. Samples were also collected from 3 replicates from each treatment before the 4th microalgae composition application and at final harvest (all from root zone). Samples were then subjected to soil health analysis. Samples were shipped in plastic bags overnight and kept cold (not frozen) with ice packs. Raw data for active carbon (Table 21), soil protein (Table 22), water holding capacity (Table 23), total dissolved solids (Table 24), total suspended solids (Table 25), and aggregation (Table 26) are shown in Tables 21-26 below.

TABLE 21
Raw Data for Active Carbon (mg/Kg)

| | | Rates | | | |
|---|---|---|---|---|---|
| Tests | Treatments | (gals/acre) | initial | Mid | Final |
| Active | Standard practice a | | 123.43 | 85.69 | 35.24 |
| Carbon | Standard practice b | | 105.93 | 126.42 | 39.40 |
| (mg/Kg) | Seaweed | 0.5 | | 128.43 | 37.32 |
| | commercial ref. | | | | |
| | Terrene | 0.24 | | 157.30 | 172.15 |
| | Terrene | 0.5 | | 103.37 | 209.83 |
| | HS399EB Organic | 0.24 | | 136.94 | 147.73 |
| | HS399EB Organic | 0.5 | | 156.18 | 176.57 |
| | HS399WB | 0.24 | | 143.43 | 74.99 |
| | HS399WB | 0.5 | | 129.10 | 59.14 |
| | PhycoTerra | 0.24 | | 87.03 | 34.98 |
| | PhycoTerra | 0.5 | | 101.58 | 31.34 |
| | GWP | 0.24 | | 109.86 | 218.66 |
| | GWP | 0.5 | | 142.76 | 199.43 |

TABLE 22
Raw Data for Soil Protein (mg/g)

| | | Rates | | | |
|---|---|---|---|---|---|
| Tests | Treatments | (gals/acre) | initial | Mid | Final |
| Soil | Standard practice a | | 1.42 | 1.04 | 0.92 |
| Protein | Standard practice b | | 1.42 | 1.26 | 0.80 |
| (mg/g) | Seaweed commercial ref. | 0.5 | | 1.08 | 0.71 |
| | Terrene | 0.24 | | 1.07 | 0.86 |
| | Terrene | 0.5 | | 1.05 | 0.80 |
| | HS399EB Organic | 0.24 | | 1.23 | 0.93 |
| | HS399EB Organic | 0.5 | | 1.14 | 0.79 |
| | HS399WB | 0.24 | | 1.10 | 0.70 |
| | HS399WB | 0.5 | | 1.21 | 0.76 |
| | PhycoTerra | 0.24 | | 1.01 | 0.88 |
| | PhycoTerra | 0.5 | | 1.10 | 0.79 |
| | GWP | 0.24 | | 1.24 | 1.28 |
| | GWP | 0.5 | | 1.25 | 0.85 |

TABLE 23
Raw Data for Water Holding Capacity (%)

| | | Rates | | | |
|---|---|---|---|---|---|
| Tests | Treatments | (gals/acre) | initial | Mid | Final |
| Water | Standard practice a | | | 24 | 25 |
| holding | Standard practice b | | | 37 | 23 |
| capacity | Seaweed commercial ref. | | | 28 | 28 |
| % | Terrene | 0.24 | | 32 | 23 |
| | Terrene | 0.5 | | 24 | 29 |
| | HS399EB Organic | 0.24 | | 35 | 29 |
| | HS399EB Organic | 0.5 | | 28 | 21 |
| | HS399WB | 0.24 | | 35 | 26 |
| | HS399WB | 0.5 | | 31 | 30 |
| | PhycoTerra | 0.24 | | 40 | 28 |
| | PhycoTerra | 0.5 | | 31 | 21 |
| | GWP | 0.24 | | 36 | 30 |
| | GWP | 0.5 | | 37 | 29 |

TABLE 24
Raw Data for Total Dissolved Solids (ppm)

| | | Rates | | | |
|---|---|---|---|---|---|
| Tests | Treatments | (gals/acre) | initial | Mid | Final |
| Total | Standard practice a | | | 160 | 37764 |
| dissolved | Standard practice b | | | 167 | 14831 |
| solids(ppm) | Seaweed | 0.5 | | 320 | 24364 |
| | commercial ref. | | | | |
| | Terrene | 0.24 | | 140 | 210 |
| | Terrene | 0.5 | | 60 | 67 |
| | HS399EB Organic | 0.24 | | 60 | 15125 |
| | HS399EB Organic | 0.5 | | 73 | 6380 |
| | HS399WB | 0.24 | | 140 | 9686 |
| | HS399WB | 0.5 | | 147 | 9980 |
| | PhycoTerra | 0.24 | | 53 | 45064 |
| | PhycoTerra | 0.5 | | 60 | 39098 |
| | GWP | 0.24 | | 47 | 133 |
| | GWP | 0.5 | | 47 | 233 |

TABLE 25
Raw Data for Total Suspended Solids (ppm)

| | | Rates | | | |
|---|---|---|---|---|---|
| Tests | Treatments | (gals/acre) | initial | Mid | Final |
| Total | Standard practice a | | | 36000 | 7771 |
| suspended | Standard practice b | | | 6140 | 19055 |
| solids(ppm) | Seaweed | 0.5 | | 31493 | 7980 |
| | commercial ref. | | | | |
| | Terrene | 0.24 | | 6477 | 7851 |
| | Terrene | 0.5 | | 7773 | 13601 |
| | HS399EB Organic | 0.24 | | 9067 | 3637 |
| | HS399EB Organic | 0.5 | | 5573 | 23676 |
| | HS399WB | 0.24 | | 4596 | 17427 |
| | HS399WB | 0.5 | | 8987 | 1529 |
| | PhycoTerra | 0.24 | | 10253 | 7351 |
| | PhycoTerra | 0.5 | | 17827 | 22739 |
| | GWP | 0.24 | | 10707 | 6465 |
| | GWP | 0.5 | | 11720 | 8781 |

TABLE 26
Raw Data for Aggregation (>1 mm PMR)

| | | Rates | | | |
|---|---|---|---|---|---|
| Tests | Treatments | (gals/acre) | initial | Mid | Final |
| Aggregation | Standard practice a | | | 0.12 | 0.23 |
| (>1 mm PMR) | Standard practice b | | | 0.15 | 0.21 |
| | Seaweed | 0.5 | | 0.09 | 0.22 |
| | commercial ref. | | | | |
| | Terrene | 0.24 | | 0.11 | 0.20 |
| | Terrene | 0.5 | | 0.11 | 0.20 |
| | HS399EB Organic | 0.24 | | 0.16 | 0.22 |
| | HS399EB Organic | 0.5 | | 0.12 | 0.19 |
| | HS399WB | 0.24 | | 0.12 | 0.18 |
| | HS399WB | 0.5 | | 0.08 | 0.23 |
| | PhycoTerra | 0.24 | | 0.07 | 0.24 |
| | PhycoTerra | 0.5 | | 0.09 | 0.20 |
| | GWP | 0.24 | | 0.09 | 0.19 |
| | GWP | 0.5 | | 0.14 | 0.21 |

Soil quality is influenced by field management and soil type. Improving the quality of coarse or fine textured soil is often a significant challenge due to the soil particle sizes. Organic matter diminishes more quickly in sandy soil than in most other soil types, yet soil active carbon doubled with the OMRI certified TERRENE® Chlorella microalgae composition 0.5 gal/acre treatment at Field Trial A's final harvest (see Table 16). A similar increase in active carbon was also recorded with Corralitos sand in Field Trial B (see FIG. 12). Active carbon and soil protein, after 9 applications of the OMRI certified TERRENE® Chlorella microalgae composition 0.5 gal/acre, were nearly twice as high as standard practice at final harvest. Various microalgal compositions were applied in Field Trial D, containing San Joaquin sandy loam soil, to determine the efficacy of microalgae compositions on strawberry growth and soil quality. Soil active carbon was almost 5 times higher than standard practice with treatments of 0.5 gal/acre the OMRI certified TERRENE® Chlorella microalgae composition, the organic Aurantiochytrium acetophilum HS399 extracted biomass (EB) microalgae composition, and GWP. FIG. 15 is a graph showing the active carbon and total dissolved solids comparison at final harvest with applications of the different microalgae compositions. As shown, total dissolved solids measurements, approximating runoff, were also drastically reduced (see FIG. 15). This data suggests that microalgae composition treatments could lead to a significant reduction of runoff nutrients and soil particles which could potentially prevent soil erosion and nutrient leaching, thereby improving runoff water quality.

### Example 8

A trial was conducted to assess soil types nationwide. Soils collected from 14 different states in the U.S.A. were used in this experiment. For soil texture information, refer to Table 13. A total of 3 treatments were conducted per soil type: an untreated control (without the OMRI certified TERRENE® Chlorella microalgae composition), the OMRI certified TERRENE® Chlorella microalgae composition at 1% v/v, and the OMRI certified TERRENE® Chlorella microalgae composition at 3% v/v. Gallon pots of soils were set up in a random arrangement. Initial soil samples before treatments were collected. A total of three microalgae composition applications were applied: on day 0, day 14, and 28. All pots received equivalent amounts of water every other day afterward until final collection. Soil triplicates from each treatment and soil type were collected for soil health screening on day 0, 7, 14, 28, 40, and 60. Raw data for active carbon (Table 27), water holding capacity (Table 28), soil protein (Table 29), and aggregation (Table 30) are shown in Tables 27-30 below. For Tables 27-30, the following Key should be used to identify the soil types, where the numbers 1-14 in the Key correlate to the numbers in the Treatments columns of Tables 27-30 below:

| | Key: |
|---|---|
| 7 | Cecil sandy loam |
| 4 | Alapaha loamy sand |
| 5 | Hurricane fine sand |
| 6 | Williaman loamy fine sand |
| 3 | Heidel sandy loam |
| 14 | Navajo fine sandy loam |
| 13 | Penistaja fine sandy loam |
| 11 | Calloway silt loam |
| 10 | Natchez silt loam |
| 12 | Renfrow silt loam |
| 9 | Crider silt loam |
| 8 | Dickson silt loam |
| 2 | Frost silt loam |
| 1 | Houston Black clay |

TABLE 27
Raw Data for Active Carbon (mg/kg)

| Tests | Treatments | Day 0 | Day 7 | % change | Day 14 | % change | Day 28 | % change | Day 40 | % change |
|---|---|---|---|---|---|---|---|---|---|---|
| Active | 1UTC | 228.11 | 239.90 | | 224.26 | | 231.37 | | 213.85 | |
| carbon | 1 1% | 228.11 | 221.28 | −7.76 | 205.16 | −8.52 | 233.71 | 1.01 | 220.62 | 3.16477 |
| (mg/kg) | 1 3% | 228.11 | 200.31 | −16.50 | 215.39 | −3.95 | 100.80 | −13.22 | 212.28 | −0.73845 |
| | 2 UTC | 143.74 | 185.62 | | 173.32 | | 167.57 | | 131.06 | |
| | 2 1% | 143.74 | 145.29 | −21.19 | 160.59 | −7.35 | 173.65 | 3.63 | 104.44 | −20.312 |
| | 2 3% | 143.74 | 127.68 | −31.22 | 172.41 | −0.52 | 179.42 | 7.08 | 94.96 | −27.5416 |
| | 3 UTC | 107.02 | 78.77 | | 86.32 | | 68.76 | | 68.81 | |
| | 3 1% | 107.02 | 59.29 | −24.73 | 106.88 | 23.83 | 64.80 | −5.77 | 79.72 | 15.86093 |
| | 3 3% | 107.02 | 95.54 | 17.48 | 102.22 | 18.42 | 70.40 | 2.38 | 88.31 | 28.3472 |
| | 4 UTC | 195.30 | 176.72 | | 288.68 | | 197.13 | | 168.89 | |
| | 4 1% | 195.30 | 214.13 | 21.17 | 285.66 | −0.14 | 177.76 | −9.83 | 149.61 | −11.4117 |
| | 4 3% | 195.30 | 178.80 | 1.18 | 285.11 | −1.23 | 173.56 | −11.96 | 186.07 | 10.17426 |
| | 5 UTC | 134.37 | 97.74 | | 198.46 | | 125.71 | | 117.10 | |
| | 5 1% | 134.37 | 121.38 | 24.19 | 224.51 | 13.13 | 99.34 | −20.98 | 162.70 | 38.93244 |
| | 5 3% | 134.37 | 76.18 | −22.06 | 230.27 | 16.03 | 101.67 | −19.12 | 189.97 | 62.22345 |
| | 6 UTC | 158.58 | 76.96 | | 198.74 | | 84.87 | | 128.09 | |
| | 6 1% | 158.58 | 163.47 | 112.42 | 218.75 | 10.07 | 89.30 | 5.23 | 138.17 | 7.873411 |
| | 6 3% | 158.58 | 152.04 | 97.56 | 214.37 | 7.86 | 92.57 | 9.08 | 164.07 | 28.09376 |
| | 7 UTC | 183.58 | 254.40 | | 323.50 | | 118.48 | | 223.71 | |
| | 7 1% | 183.58 | 208.42 | −18.08 | 320.21 | −1.02 | 151.39 | 27.78 | 244.29 | 9.201997 |
| | 7 3% | 183.58 | 222.70 | −12.46 | 314.45 | −2.80 | 220.58 | 86.18 | 281.19 | 25.26801 |
| | 8 UTC | 107.02 | 103.08 | | 263.60 | | 259.92 | | 173.92 | |
| | 8 1% | 107.02 | 226.79 | 120.12 | 284.52 | 7.94 | 259.99 | −2.28 | 256.18 | 47.29708 |
| | 8 3% | 107.02 | 269.27 | 161.35 | 290.89 | 10.35 | 258.05 | −0.72 | 210.91 | 21.26801 |
| | 9 UTC | 81.24 | 71.57 | | 304.99 | | 250.23 | | 171.16 | |
| | 9 1% | 81.24 | 202.40 | 182.82 | 327.96 | 7.53 | 304.80 | 21.81 | 200.34 | 17.05128 |
| | 9 3% | 81.24 | 311.22 | 334.86 | 340.46 | 11.63 | 307.15 | 22.75 | 196.67 | 14.90309 |
| | 10 UTC | 145.30 | 115.35 | | 282.02 | | 294.92 | | 143.58 | |
| | 10 1% | 145.30 | 157.82 | 36.82 | 231.77 | −17.82 | 254.70 | −13.64 | 106.12 | −26.0878 |
| | 10 3% | 145.30 | 183.26 | 58.87 | 271.79 | −3.63 | 237.53 | −19.46 | 171.22 | 19.24631 |
| | 11 UTC | 208.58 | 229.94 | | 268.61 | | 262.22 | | 145.91 | |
| | 11 1% | 208.58 | 175.92 | −23.49 | 252.91 | −5.84 | 183.20 | −30.14 | 124.70 | −14.5324 |
| | 11 3% | 208.58 | 191.65 | −16.65 | 286.57 | 6.69 | 247.41 | −5.65 | 149.56 | 2.500206 |
| | 12 UTC | 266.39 | 190.61 | | 325.68 | | 298.44 | | 183.30 | |
| | 12 1% | 266.39 | 210.53 | 10.45 | 330.23 | 1.40 | 279.86 | −6.23 | 180.56 | −1.49264 |
| | 12 3% | 266.39 | 215.78 | 13.21 | 235.86 | −27.58 | 265.75 | −10.95 | 156.17 | −14.802 |
| | 13 UTC | 61.71 | 60.33 | | 101.96 | | 45.24 | | 61.00 | |
| | 13 1% | 61.71 | 45.65 | −22.82 | 93.17 | −8.61 | 46.86 | 3.56 | 70.44 | 15.46133 |
| | 13 3% | 61.71 | 57.99 | −3.87 | 64.93 | −36.31 | 56.07 | 23.93 | 92.60 | 51.79546 |
| | 14 UTC | 144.52 | 101.72 | | 178.10 | | 145.09 | | 94.88 | |
| | 14 1% | 144.52 | 106.70 | 4.90 | 176.05 | −1.15 | 90.53 | −37.61 | 84.11 | −11.3451 |
| | 14 3% | 144.52 | 99.10 | −2.58 | 176.74 | −0.77 | 103.25 | −28.85 | 80.37 | −15.2912 |

TABLE 28
Raw Data for Water Holding Capacity (%)

| | | | | % | | % | | % | | % |
|---|---|---|---|---|---|---|---|---|---|---|
| Tests | Treatments | Day 0 | Day 7 | change | Day 14 | change | Day 28 | change | Day 40 | change |
| Water | 1UTC | 81.52 | 73.96 | | 80.96 | | 75.53 | | 73.25 | |
| holding | 1 1% | 81.62 | 74.46 | 0.68 | 73.61 | 9.08 | 76.47 | 1.24 | 74.24 | 1.346733 |
| capacity | 1 3% | 81.62 | 72.39 | −1.45 | 74.22 | 8.32 | 74.48 | −1.39 | 73.27 | 0.025874 |
| % | 2 UTC | 72.24 | 69.68 | | 69.88 | | 74.69 | | 65.36 | |
| | 2 1% | 72.24 | 69.10 | −0.82 | 66.87 | −4.31 | 73.63 | −1.42 | 64.25 | −1.69113 |
| | 2 3% | 72.24 | 64.37 | −7.61 | 69.81 | −0.10 | 70.65 | −5.40 | 65.93 | 0.867778 |
| | 3 UTC | 39.43 | 45.61 | | 36.20 | | 37.99 | | 40.09 | |
| | 3 1% | 39.43 | 49.87 | 9.33 | 41.82 | 15.52 | 43.13 | 13.52 | 43.96 | 9.651894 |
| | 3 3% | 39.43 | 49.52 | 8.57 | 42.58 | 17.61 | 44.46 | 17.04 | 47.15 | 17.60162 |
| | 4 UTC | 45.09 | 51.69 | | 48.34 | | 48.67 | | 47.86 | |
| | 4 1% | 45.09 | 55.15 | 6.69 | 51.03 | 5.58 | 53.95 | 10.84 | 49.97 | 4.403128 |
| | 4 3% | 45.09 | 53.14 | 2.80 | 49.19 | 1.75 | 53.73 | 10.40 | 56.48 | 17.99964 |
| | 5 UTC | 41.93 | 41.12 | | 39.85 | | 39.63 | | 41.70 | |
| | 5 1% | 41.93 | 49.96 | 14.20 | 41.75 | 4.77 | 45.68 | 15.29 | 41.67 | −0.06074 |
| | 5 3% | 41.93 | 48.59 | 18.18 | 42.64 | 7.01 | 46.15 | 16.47 | 43.52 | 4.370647 |
| | 6 UTC | 49.10 | 47.14 | | 41.11 | | 41.08 | | 41.73 | |
| | 6 1% | 49.10 | 51.54 | 9.33 | 47.69 | 16.00 | 46.15 | 12.32 | 45.70 | 9.512885 |
| | 6 3% | 49.10 | 49.70 | 5.43 | 48.90 | 18.96 | 48.88 | 18.99 | 49.31 | 18.15539 |
| | 7 UTC | 51.22 | 53.19 | | 48.74 | | 48.09 | | 48.02 | |
| | 7 1% | 51.22 | 52.19 | −1.87 | 45.70 | −6.24 | 55.15 | 14.67 | 51.31 | 6.865715 |
| | 7 3% | 51.22 | 52.09 | −2.06 | 48.60 | −0.30 | 52.04 | 8.22 | 56.64 | 17.9583 |
| | 8 UTC | 77.06 | 59.18 | | 69.35 | | 67.59 | | 63.62 | |
| | 8 1% | 77.06 | 67.40 | 13.88 | 73.38 | 5.82 | 67.09 | −0.74 | 64.90 | 2.014986 |
| | 8 3% | 77.06 | 67.12 | 13.40 | 60.52 | −12.73 | 65.63 | −2.90 | 64.42 | 1.254167 |
| | 9 UTC | 69.26 | 64.41 | | 60.93 | | 65.55 | | 63.76 | |
| | 9 1% | 69.26 | 67.33 | 4.54 | 65.09 | 6.82 | 68.33 | 4.23 | 64.89 | 1.766762 |
| | 9 3% | 69.26 | 63.52 | −1.21 | 69.73 | 14.44 | 64.92 | −0.96 | 64.29 | 0.836546 |
| | 10 UTC | 67.06 | 59.22 | | 64.07 | | 61.24 | | 55.21 | |
| | 10 1% | 67.06 | 64.51 | 8.93 | 61.18 | −4.51 | 62.75 | 2.47 | 57.05 | 3.332235 |
| | 10 3% | 67.06 | 63.70 | 7.56 | 59.38 | −7.31 | 59.90 | −2.18 | 56.83 | 2.929488 |
| | 11 UTC | 59.26 | 60.97 | | 67.76 | | 63.84 | | 57.33 | |
| | 11 1% | 59.26 | 67.43 | 10.58 | 76.27 | 12.56 | 55.27 | 2.24 | 60.55 | 5.624304 |
| | 11 3% | 59.26 | 67.66 | 10.97 | 70.69 | 4.33 | 64.57 | 1.14 | 57.66 | 0.571388 |
| | 12 UTC | 61.30 | 63.48 | | 62.70 | | 64.21 | | 59.47 | |
| | 12 1% | 61.30 | 58.02 | −8.61 | 65.61 | 4.64 | 62.19 | −3.15 | 59.07 | −0.68691 |
| | 12 3% | 61.30 | 62.97 | −0.80 | 65.79 | 4.92 | 64.28 | 0.10 | 60.60 | 1.88407 |
| | 13 UTC | 35.30 | 36.28 | | 34.38 | | 38.45 | | 37.62 | |
| | 13 1% | 35.30 | 35.41 | −2.41 | 32.00 | −6.94 | 40.05 | 4.14 | 39.45 | 4.895425 |
| | 13 3% | 35.30 | 32.39 | −10.72 | 34.32 | −0.17 | 41.32 | 7.45 | 36.47 | −3.05517 |
| | 14 UTC | 51.05 | 51.20 | | 52.89 | | 48.84 | | 45.60 | |
| | 14 1% | 51.05 | 48.42 | −5.44 | 55.12 | 4.22 | 51.96 | 6.40 | 47.60 | 4.395524 |
| | 14 3% | 51.02 | 50.47 | −1.44 | 53.86 | 1.84 | 50.46 | 3.33 | 48.95 | 7.352629 |

TABLE 29
Raw Data for Soil Protein (mg/g)

| | | | | % | | % | | % | | % |
|---|---|---|---|---|---|---|---|---|---|---|
| Tests | Treatments | Day 0 | Day 7 | change | Day 14 | change | Day 28 | change | Day 40 | change |
| Soil | 1UTC | 1.09 | 1.35 | | 1.10 | | 0.87 | | 1.15 | |
| Protein | 1 1% | 1.09 | 1.34 | −0.25 | 1.42 | 29.00 | 0.88 | 0.53 | 1.26 | 9.0 |
| (mg/g) | 1 3% | 1.09 | 1.50 | 11.39 | 1.09 | −1.21 | 0.90 | 3.20 | 1.31 | 13.3 |
| | 2 UTC | 2.96 | 3.35 | | 2.85 | | 2.75 | | 2.66 | |
| | 2 1% | 2.96 | 3.21 | −4.37 | 2.94 | 13.94 | 2.95 | 7.14 | 2.77 | 4.0 |
| | 2 3% | 2.96 | 3.34 | −0.30 | 2.53 | −2.06 | 2.75 | −0.28 | 2.75 | 3.2 |
| | 3 UTC | 2.01 | 2.18 | | 2.32 | | 1.50 | | 1.97 | |
| | 3 1% | 2.01 | 2.09 | −4.43 | 2.46 | 6.43 | 1.48 | −1.32 | 2.12 | 7.8 |
| | 3 3% | 2.01 | 2.20 | 0.61 | 2.41 | 3.88 | 1.36 | −9.59 | 2.07 | 5.4 |
| | 4 UTC | 4.02 | 5.48 | | 5.64 | | 1.41 | | 4.75 | |
| | 4 1% | 4.02 | 6.13 | 11.85 | 6.53 | 15.83 | 4.87 | 245.35 | 5.50 | 15.9 |
| | 4 3% | 4.02 | 7.29 | 33.01 | 6.63 | 17.65 | 4.80 | 240.23 | 6.94 | 46.1 |
| | 5 UTC | 2.22 | 4.66 | | 4.81 | | 2.84 | | 4.05 | |
| | 5 1% | 2.22 | 4.29 | −7.95 | 4.87 | 1.20 | 3.34 | 17.69 | 3.92 | −3.3 |
| | 5 3% | 2.22 | 5.12 | 10.02 | 4.98 | 3.39 | 3.49 | 22.97 | 4.57 | 12.7 |
| | 6 UTC | 3.49 | 3.74 | | 4.00 | | 2.84 | | 3.55 | |
| | 6 1% | 3.49 | 3.66 | −2.05 | 3.53 | −11.75 | 2.79 | −1.66 | 3.35 | −5.6 |
| | 6 3% | 3.49 | 3.71 | −0.71 | 3.01 | −24.66 | 3.01 | 5.90 | 3.82 | 7.6 |
| | 7 UTC | 2.22 | 5.44 | | 4.55 | | 4.03 | | 5.03 | |
| | 7 1% | 2.22 | 4.60 | −15.45 | 4.02 | −11.75 | 3.62 | −10.35 | 4.68 | −7.0 |
| | 7 3% | 2.22 | 4.23 | −22.19 | 4.16 | −8.61 | 3.16 | −21.55 | 5.89 | 16.9 |
| | 8 UTC | 3.17 | 3.40 | | 2.74 | | 2.84 | | 3.22 | |
| | 8 1% | 3.17 | 3.64 | 7.16 | 2.92 | 6.45 | 2.88 | 1.52 | 4.18 | 29.8 |
| | 8 3% | 3.17 | 3.66 | 7.65 | 2.76 | 0.85 | 2.48 | −12.60 | 4.06 | 26.3 |
| | 9 UTC | 4.89 | 5.48 | | 5.77 | | 5.49 | | 4.51 | |
| | 9 1% | 4.89 | 6.02 | 9.73 | 5.07 | −12.18 | 7.76 | 41.39 | 5.65 | 25.3 |
| | 9 3% | 4.89 | 5.51 | 0.55 | 4.93 | −14.55 | 6.16 | 12.18 | 5.38 | 19.3 |
| | 10 UTC | 2.32 | 4.29 | | 3.47 | | 4.05 | | 3.29 | |
| | 10 1% | 2.32 | 3.62 | −15.61 | 3.33 | −3.94 | 3.56 | −12.08 | 2.92 | −11.2 |
| | 10 3% | 2.32 | 3.59 | −16.46 | 3.65 | 5.09 | 3.52 | −13.14 | 3.41 | 3.6 |
| | 11 UTC | 2.50 | 3.43 | | 3.23 | | 3.06 | | 2.97 | |
| | 11 1% | 2.50 | 2.87 | −16.42 | 2.81 | −13.09 | 3.14 | 2.48 | 2.45 | −17.5 |
| | 11 3% | 2.50 | 3.18 | −7.39 | 2.97 | −8.25 | 3.37 | 9.92 | 2.58 | −13.1 |
| | 12 UTC | 3.48 | 3.91 | | 3.59 | | 2.82 | | 3.10 | |
| | 12 1% | 3.48 | 3.80 | −2.82 | 3.89 | 8.46 | 3.03 | 7.39 | 3.19 | 3.0 |
| | 12 3% | 3.48 | 3.67 | −5.97 | 3.81 | 6.13 | 2.83 | 0.36 | 3.31 | 6.8 |
| | 13 UTC | 0.43 | 0.81 | | 0.68 | | 0.59 | | 0.82 | |
| | 13 1% | 0.43 | 0.82 | 2.07 | 0.68 | 0.36 | 0.62 | 6.68 | 0.81 | −1.2 |
| | 13 3% | 0.43 | 0.79 | −2.07 | 0.57 | −15.34 | 0.74 | 25.89 | 0.96 | 17.2 |
| | 14 UTC | 1.19 | 1.02 | | 0.91 | | 0.69 | | 0.87 | |
| | 14 1% | 1.19 | 1.06 | 4.59 | 1.29 | 42.28 | 0.69 | 0.33 | 0.96 | 10.2 |
| | 14 3% | 1.19 | 1.03 | 0.98 | 1.27 | 39.71 | 0.74 | 7.78 | 1.02 | 16.9 |

TABLE 30
Raw Data for Aggregation (>1 mm PMR)

| Aggregation | | | | | | |
|---|---|---|---|---|---|---|
| >1 mm PMR | Treatment | Day 7 | Day 28 | magnitude | 40 | magnitude |
| | 1UTC | 50.5 | 29.3 | | 41.1 | |
| | 1 1% | | 25.6 | 0.9 | 40.3 | 1.0 |
| | 1 3% | | 42.5 | 1.4 | 39.5 | 1.0 |
| | 2 UTC | 57.5 | 25.1 | | 49.8 | |
| | 2 1% | | 27.6 | 1.1 | 47.8 | 1.0 |
| | 2 3% | | 30.5 | 1.2 | 48.7 | 1.0 |
| | 3 UTC | 19.8 | 19.5 | | 21.1 | |
| | 3 1% | 29.8 | 24.4 | 1.3 | 23.3 | 1.1 |
| | 3 3% | 19.8 | 24.5 | 1.3 | 25.7 | 1.2 |
| | 4 UTC | 15.5 | 18.4 | | 14.7 | |
| | 4 1% | 28.8 | 27.3 | 1.5 | 25.5 | 1.7 |
| | 4 3% | 26.4 | 25.6 | 1.4 | 27.9 | 1.9 |
| | 5 UTC | 4.1 | 4.5 | | 1.8 | |
| | 5 1% | 5.1 | 4.5 | 1.0 | 6.6 | 3.7 |
| | 5 3% | 14.6 | 14.3 | 3.2 | 15.2 | 8.5 |
| | 6 UTC | 5.1 | 8.1 | | 7.3 | |
| | 6 1% | 26.8 | 16.5 | 2.0 | 15.8 | 2.2 |
| | 6 3% | 16.6 | 20.5 | 2.5 | 20.4 | 2.8 |
| | 7 UTC | 28.9 | 27.0 | | 31.9 | |
| | 7 1% | 34.9 | 42.9 | 1.6 | 33.5 | 1.1 |
| | 7 3% | 43.5 | 40.6 | 1.5 | 35.5 | 1.1 |
| | 8 UTC | 55.2 | 34.7 | | 48.2 | |
| | 8 1% | | 27.8 | 0.8 | 45.8 | 0.9 |
| | 8 3% | | 33.0 | 1.0 | 45.9 | 1.0 |
| | 9 UTC | 42.3 | 38.8 | | 59.1 | |
| | 9 1% | | 43.8 | 1.1 | 43.8 | 0.7 |
| | 9 3% | | 46.8 | 1.2 | 49.2 | 0.8 |
| | 10 UTC | 43.1 | 40.9 | | 35.0 | |
| | 10 1% | | 40.5 | 1.0 | 41.2 | 1.2 |
| | 10 3% | | 42.4 | 1.0 | 48.8 | 1.4 |
| | 11 UTC | 46.4 | 38.0 | | 57.1 | |
| | 11 1% | | 45.2 | 1.2 | 51.6 | 0.9 |
| | 11 3% | | 44.7 | 1.2 | 52.7 | 0.9 |
| | 12 UTC | 45.3 | 40.5 | | 58.4 | |
| | 12 1% | | 51.2 | 1.3 | 48.8 | 0.8 |
| | 12 3% | | 46.2 | 1.1 | 47.7 | 0.8 |
| | 13 UTC | 26.5 | 16.8 | | 21.5 | |
| | 13 1% | 25.3 | 10.6 | 0.6 | 29.4 | 1.4 |
| | 13 3% | 37.7 | 18.4 | 1.1 | 29.8 | 1.4 |
| | 14 UTC | 24.7 | 42.7 | | 41.9 | |
| | 14 1% | | 43.0 | 1.0 | 41.0 | 1.0 |
| | 14 3% | | 43.3 | 1.0 | 45.0 | 1.1 |

This experiment showed changes in water holding capacity across the various soil types. The addition of organic matter usually results in an increase in the water holding capacity of soil because it either increases micro- and macro-pore numbers in the soil either by “gluing” soil particles together and increasing aggregation or by creating favorable living conditions for soil microorganisms. These soil microorganisms are then able to interact more significantly with the active carbon fraction and proteins in the soil.

Soil water is held by adhesive and cohesive forces within the soil and an increase in pore space will lead to an increase in water holding capacity of the soil. Consequently, less irrigation water is needed to irrigate the same crop.

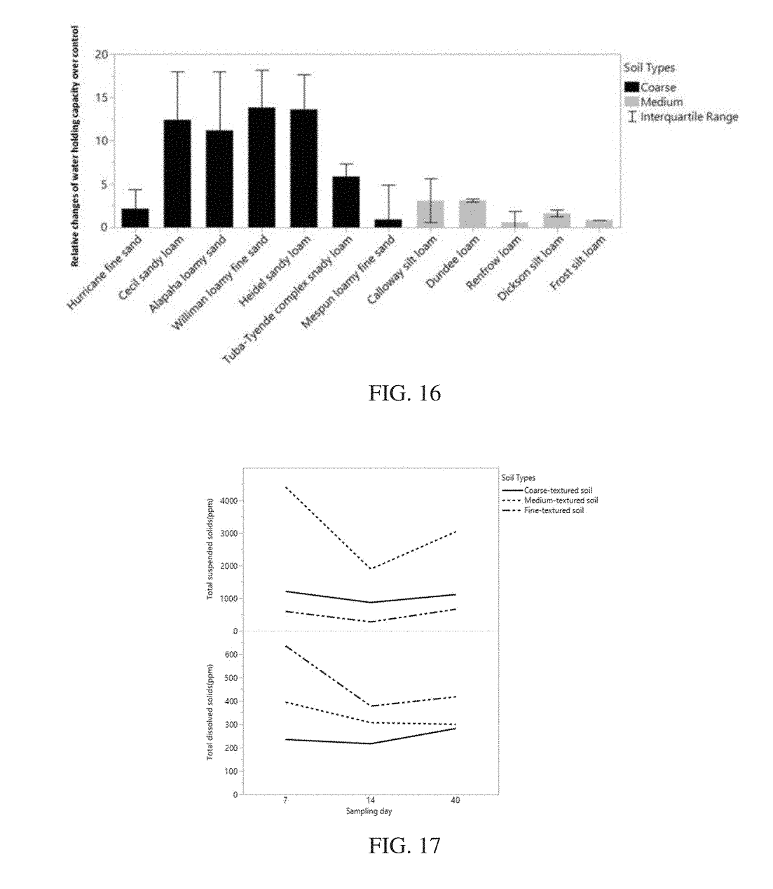

The majority of agricultural lands are comprised of either coarse- or medium-textured soil. The pH range of 5.5 to 7.5 is optimal for most crops. With multiple applications of the OMRI certified TERRENE® Chlorella microalgae composition over a 40-day course, there was a potential 9% average increase in water holding capacity in course soil. An average 2% water holding capacity was elevated in medium soil. FIG. 16 is a graph showing relative changes of water holding capacity with the OMRI certified TERRENE® Chlorella microalgae composition compared to the control over a 40-day course.

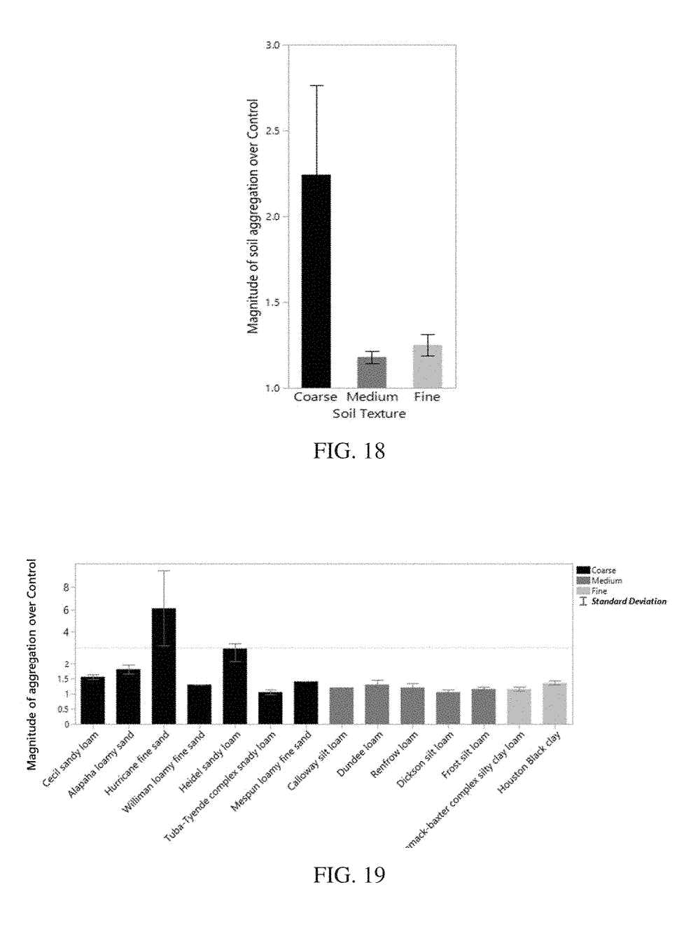

FIG. 17 is a graph showing the total suspended solids (ppm) and total dissolved solids (ppm) trendlines across the 40-day study course. There is currently no federally enforceable standard for total dissolved solids and total suspended solids in drinking water. The EPA set a non-enforceable secondary standard of 500 ppm for total dissolved solids, but this value is only a guideline to assist public water systems in managing their drinking water for aesthetic considerations. FIG. 18 is a graph showing soil aggregation improvement based on soil textures compared to the control group (magnitude differences). FIG. 19 is a graph showing soil aggregation improvement (magnitude) among all soil types compared to the control group.

When water hits bare soil, individual soil particles can be detached from soil clods if they are not sufficiently stable. These particles can clog surface pores and form thin, impermeable layers of sediment at the surface, referred to as surface crusts, which can range from a few millimeters to 1 cm (USDA). These surface crusts hinder the passage of water into the soil below, increasing runoff and decreasing water absorption. With the aid of the OMRI certified TERRENE® Chlorella microalgae composition, both total suspended solids and total dissolved solids were relatively steady over the 40-day course, indicating low, stable levels of nutrient and soil runoff. Soil treated with the OMRI certified TERRENE® Chlorella microalgae composition had on average a 1.4 magnitude increase in the ideal aggregation size range in clay and a 6.3 magnitude increase in ideal aggregation in sand over control.

The health of soils can be degraded by erosion, desertification, salinization, and other soil contaminants, all of which influence the soil microbial community. Soil organic matter dynamics, nutrient cycling, and soil structure are all influenced by microbial processes and are often negatively affected by management. Soil microbial communities often change more rapidly with management and environment. The soil microbial community is more diverse than any other group of organisms, but we know so little about this diverse genetic resource and how they will respond to microalgae product. “Nextgen” sequencing methods are available to enhance the knowledge of what is happening underground after applying microalgae products. As indicated in this platform analysis, molecular level research was conducted to increase our understanding of the diversity and function of microbial communities after product treatments.

### Example 9

An experiment was conducted to elucidate the effects on the soil microbiome at the field level from the application of microalgae compositions using DNA sequencing. An additional investigation was undertaken to quantify desirable functional genes from environmental samples.

Soil samples collected at the time of final harvest were received from multiple external field trials in Crow River, Minn., conducted during spring of 2016. Multiple microalgae composition treatments were applied in the field setting to ascertain effects on the growth and yield of snap beans, snap peas, and sweet corn. All samples were aliquoted and frozen at ˜80° C. prior to standard soil DNA extraction. Purified DNA extracts were later quantified and standardized to 15 ng/μl for 16S metagenomic sequencing of the V3-V4 hypervariable region using 357F-783R primers. Bioinformatic tools were applied to analyze data. Furthermore, various primer pairs (Table 1) were selected as biomarkers via qPCR to study the nitrogen fixing bacteria and nitrite oxidizers, which were targeting the nifH subunit of nitrogenase, and the nxrA subunit of nitrite oxidoreductase, respectively.

TABLE 31
Primer Sets Targeting N Cycle 16S Genes Used for the Protocol

| | Target |
|---|---|
| Primer Name | gene |
| DVV | nifH |
| IGK3 | nifH |
| Nbct-R2norAR | nxrA |
| Nbct-F1norAF | nxrA |

The sequencing data indicates that microalgae composition application is associated with measurable shifts in the makeup of the bacterial communities as compared to soil which received standard practice. Furthermore, certain bacterial genera were differentially increased in treated soils which showed a high degree of sequence matching to Bacillus megaterium (99.5%), Gaiella occulta (98%), and Nitrospira japonica (99%). This indicates that the microalgae compositions likely aid shifting bacterial communities and do so in a manner that enriches beneficial microbes that are associated with plant growth promotion and nutrient cycling (Ortiz et al 2008, Zaidi et al).

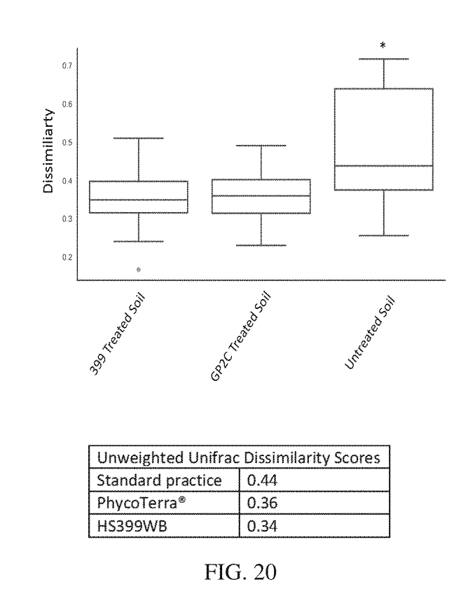

FIG. 20 shows a Boxplot of Bray Curtis dissimilarity scores grouped by treatment type. The soil treated with the Aurantiochytrium acetophilum HS399 whole biomass (WB) microalgae composition includes all products with Aurantiochytrium acetophilum HS399 whole biomass (WB) as the base. Soil treated with GP2C (PHYCOTERRA® Chlorella microalgae composition) includes all products with Chlorella cells as the base. Untreated soil was comprised of samples that received normal fertilizer and no microalgae products. Untreated soil communities were significantly less similar to the treated soil groups (* indicates significant differences between treatments, p<0.05).

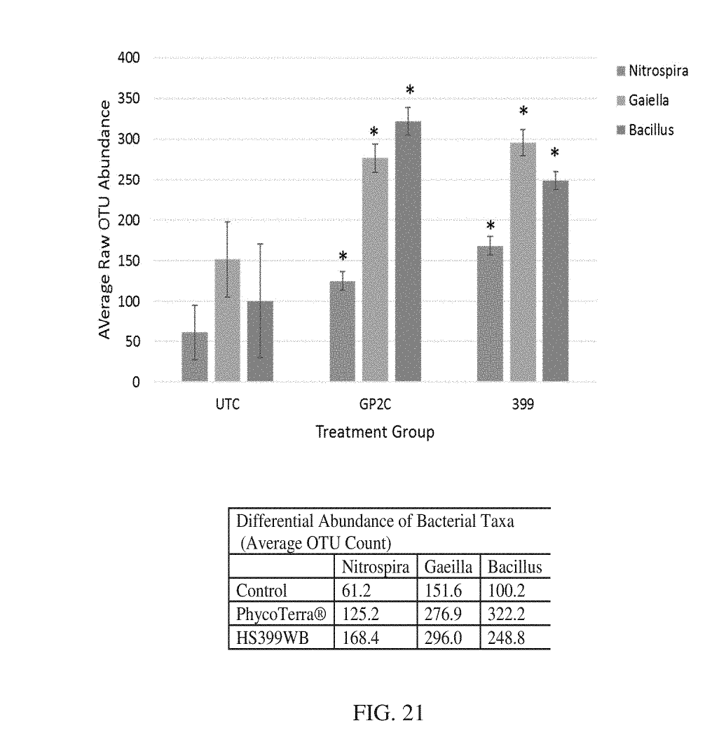

FIG. 21 is a bar chart denoting actual sequence variant (OTU) counts for three differentially abundant genera as they appear in each treatment group wherein * indicates genera are significantly higher than in control (UTC) (DESeq2, p<0.05).

Applicant confirmed and monitored soil microbiome community structure changes after treatment with the PHYCOTERRA® Chlorella microalgae composition and the Aurantiochytrium acetophilum HS399 whole biomass (WB) microalgae composition. Data generated from qPCR indicates nifH gene abundance has a stronger response than nxrA and is also associated with a stronger response in soil treated with the PHYCOTERRA® Chlorella microalgae composition. This supports data obtained in microbiome sequencing where beneficial soil bacteria increased in abundance. It is concluded that the PHYCOTERRA® Chlorella microalgae composition application in the soil is helpful in sustaining the growth of bacteria that is of functional importance to soil.

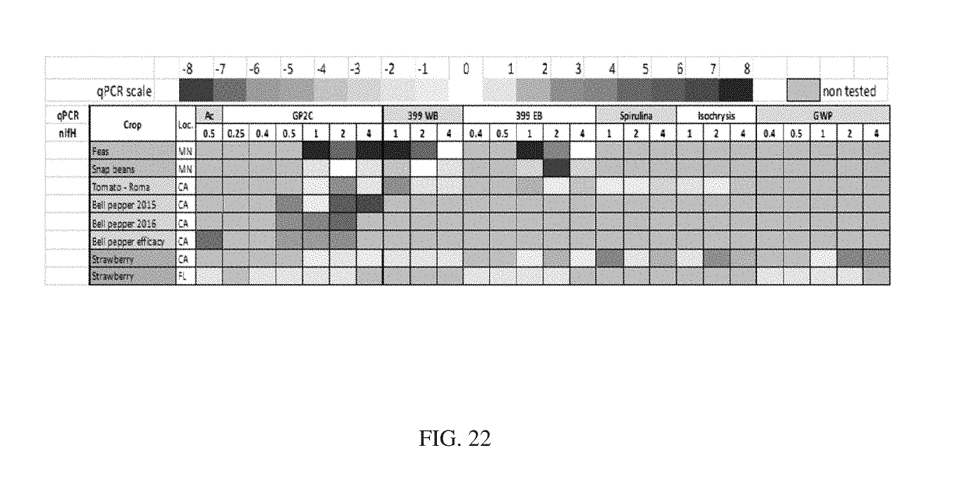

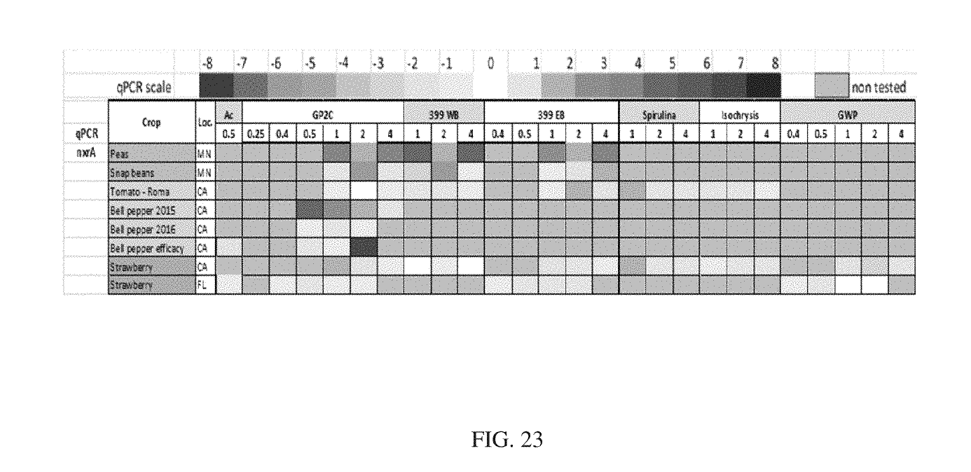

FIG. 22 and FIG. 23 below represent relative changes of either nifH gene, or nxrA gene abundance over control. FIG. 22 shows the relative change of nifH gene abundance color scheme chart for Picust (prediction) and qPCR (quantification) in soils treated with the PHYCOTERRA® Chlorella microalgae composition (GP2C), the Aurantiochytrium acetophilum HS399 whole biomass (WB) microalgae composition, the Aurantiochytrium acetophilum HS399 extracted biomass (EB) microalgae composition, Spirulina microalgae composition, Isochrysis microalgae composition, and GWP. FIG. 23 shows the change of nxrA gene abundance color scheme chart for qPCR (quantification) in soils treated with the PHYCOTERRA® Chlorella microalgae composition (GP2C), the Aurantiochytrium acetophilum HS399 whole biomass (WB) microalgae composition, the Aurantiochytrium acetophilum HS399 extracted biomass (EB) microalgae composition, Spirulina microalgae composition, Isochrysis microalgae composition, and GWP. Both nifH and nxrA gene were detected and quantified across all sediment samples. The efficiency value for amplification of this target gene was 92% (nifH) and 95% (nxrA) and logarithmic regression curves (R²) reached a value of 0.99. The amplification specificity was robust for both targeted genes with single peaks being detected during a melting curve analysis. Statistically similar nifH and nxrA gene densities (P>0.05) were observed in either nifH abundance or nxrA abundance across samples from different fields (P>0.05). The most positive response was shown with the PHYCOTERRA® Chlorella microalgae composition 1 gal/acre treatment in various crops, indicating that the abundance of nifH increased after treatment. As to nxrA, there was a different level of abundance densities in treatment application rates, especially with pea and bell pepper.

The changes observed from NGS data were at a high categorical level, which implies the communities responded to the microalgae composition application. While this change is significant, it does not denote a positive or negative change. However, differential abundance analysis indicated the organisms associated with the change in treated soils are either directly beneficial to plants (Bacillus,1) or contribute to the soil nitrogen cycle (Nitrospira,2). The qPCR data confirmed that beneficial soil microbes increased in abundance in soils treated with the microalgae compositions. Altogether, the data suggests that supplementing a field with microalgae composition treatments directly contributes to a healthier soil microbiome, consequently leading to healthier soil.

Multiple in-house experiments were conducted in tandem with external field trials to collect a comprehensive set of data. Each experimental design was driven by the preceding results, which provided a data-driven timeline for this body of work. The first efficacy study provided the initial study platform for all subsequent experiments. This experiment demonstrated statistically significant changes to biological and physical soil health indicators in product treated soil. Specifically, active carbon, soil protein, and soil aggregation levels were all increased compared to the untreated control (water only). All assays illustrate important soil features with an integral relationship to organic matter content of the soil. This initial assemblage of data suggests the product provides a short-term substrate of organic matter which enhances the health of the soil. The observed increases leveled off after a certain period of time, which prompted experimentation to determine the effects of multiple applications to sustain the beneficial effect.

Two new aspects of the application frequency study involved multiple bi-weekly applications of the products and the implementation of water holding capacity as a metric. The data again showed a significant increase in active carbon, soil protein, and aggregation. The water holding capacity assay was introduced with the second run of this experiment and it too showed significant improvement in product treated soils. The experiment also illustrated how repeat applications of the product continued to improve active carbon and protein content of the soil. Multiple applications of the products also provided an economic opportunity in lieu of a single amendment to the soil. As such, more product is required to sustain soil health levels which implies a longer term purchasing commitment from the customer. Due to these economic implications, comparison of the microalgae products to existing commercial products, which claim similar effects, was warranted.

In the product comparison study, the same soil testing platform was used as in previous studies. Several commercial products were applied once to the soil and tested in conjunction with the Heliae microalgae products. In all assays applied, the microalgae products performed as well as or better than the commercial products. The tested products were all biologically based with most of them being composed of a proprietary mixture of bacteria cultures. This experiment provided evidence that live plant growth promoting bacteria do not affect soil health as significantly as microalgae-based products.

Three Arizona field trials were set up to confirm the positive effects on soil health could be applied to field conditions. One trial was conducted externally by a third party in a Yuma, Ariz. bell pepper field, one trial was conducted in a local Gilbert, Ariz. alfalfa field, and the third was conducted in Goodyear, Ariz. with an organic lettuce grower. The results for active carbon, soil protein, and water holding capacity were replicated for all three trials of the microalgae products. Although soil health metrics showed a somewhat undulating pattern in the alfalfa trial—potentially due to the climate changes—by day 260, the product treated soils showed significantly higher active carbon, soil protein, water holding capacity, and aggregation levels than standard practice. The Yuma bell pepper trial also provided evidence that microalgae products impact the water holding dynamics of soils; product treated soils in this trial were shown to greatly improve water holding capacity despite fertilizer and irrigation stress. This is especially significant given that the field trial was conducted in an arid area. Duncan lettuce trials provided very strong evidence that aggregate formation is an important factor influencing germination and root growth. Moreover, the results from all field trials are highly encouraging given they were applied in real world conditions in actively managed fields.

The California strawberry trials held in Guadalupe, Santa Maria, Oxnard, and Fresno served to illustrate the effectiveness of the products on soil health in a different geographical region and with a crop of high economic importance. The trials allowed for testing of normal and organic field management practices and brought to light the similar impact our products have upon the soil in either scenario.

This set of experiments served to delineate the potential for microalgae products to become an important force for improving soil biological and physical health in multiple testing modalities. These results were also repeated with statistical significance across both greenhouse experiments and field trials, which provides solid support that Heliae microalgae products can be used to improve the health of agricultural soils. Testing on diverse soil types establishes the effectiveness of our microalgae products and indicates considerable positive effects on both soil health and potential agricultural benefits.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto. All patents and references cited herein are explicitly incorporated by reference in their entirety.

### REFERENCES

Dinel H, Levesque P E M, Jambu P, Righi D. 1992. Microbial activity and long-chain aliphatics in the formation of stable soil aggregates. Soil Sci Soc Am J. 1992; 56:1455-1463.
Ortiz-Castro R, Valencia-Cantero E, Lopez-Bucio J. Plant growth promotion by Bacillus megaterium involves cytokinin signaling. Plant Signaling & Behavior. 2008; 3(4):263-265.
United States Department of Agriculture and Natural Resources Conservation Service. 2006 Land Resource Regions and Major Land Resource Areas of the United States, the Caribbean, and the Pacific Basin. USDA Handbook 296.
Viji R. and Prasanna P Rajesh. 2012. Assessment of water holding capacity of major soil series of lalgudi, Trichy India. J Environ. Res Develop Vol. 7 No. 1A.
Zaidi, M. S. Khan (eds.), Microbial Strategies for Vegetable Production, Chapter 2 “Plant Growth Promoting Bacteria: Importance in vegetable production”. DOI 10.1007/978-3-319-54401-4_2.

What is claimed is:

1. A method of improving health of soil comprising the step of administering to the soil a liquid composition treatment comprising a culture of microalgae, the microalgae comprising at least one of pasteurized Chlorella cells and pasteurized Aurantiochytrium acetophilum HS399 cells in an effective amount to improve at least one soil characteristic.

2. The method of claim 1 wherein administering comprises contacting soil in the immediate vicinity of a plant, seedling, or seed with an effective amount of the liquid composition treatment.

3. The method of claim 2 wherein the liquid composition is administered at a rate in the range of 0.5-6 gal/acre.

4. The method of claim 3 wherein the liquid composition comprises between 200 g-2,400 g per acre of at least one of pasteurized Chlorella cells and pasteurized Aurantiochytrium acetophilum HS399 cells.

5. The method of claim 2 wherein the liquid composition is administered at a concentration of 0.3% v/v-3.0% v/v.

6. The method of claim 5 wherein the liquid composition comprises between 1.2-24 g of pasteurized Chlorella cells only per gallon of carrier volume.

7. The method of claim 1 wherein the liquid composition treatment further comprises phosphoric acid and potassium sorbate.

8. The method of claim 1 wherein the liquid composition treatment further comprises citric acid.

9. The method of claim 1 wherein the pasteurized Chlorella cells and the pasteurized Aurantiochytrium acetophilum HS399 cells are pasteurized at a temperature in the range of 65° C.-70° C.

10. The method of claim 1 wherein the at least one of pasteurized Chlorella cells and pasteurized Aurantiochytrium acetophilum HS399 cells are pasteurized for between 90-150 minutes.

11. The method of claim 2 wherein the soil characteristic is one of an amount of active carbon in the soil, an amount of protein in the soil, an amount of total suspended solids lost in run-off from the soil, an amount of total dissolved solids lost in run-off from the soil, an amount of healthy bacteria in the soil, an amount of nifH gene in the soil, an amount of nxrA gene in the soil, water holding capacity of the soil, and soil aggregation.

12. The method of claim 11 wherein the healthy bacteria comprises at least one of Bacillus megaterium, Gaiella occulta, and Nitrospira japonica.

13. The method of claim 1 wherein the Aurantiochytrium acetophilum HS399 cells have been subjected to an extraction process to remove oils from the Aurantiochytrium acetophilum HS399 cells.

14. The method of claim 1 wherein the liquid composition comprises pasteurized Chlorella cells and pasteurized Aurantiochytrium acetophilum HS399 cells in a ratio of 25:75.

15. A method of improving health of soil comprising the step of administering to the soil a liquid composition treatment comprising a culture of microalgae, the microalgae comprising at least one of pasteurized Chlorella cells and pasteurized Aurantiochytrium acetophilum HS399 cells in an effective amount to at least one of increase an amount of active carbon in the soil, increase an amount of protein in the soil, increase an amount of healthy bacteria in the soil, increase an amount of nifH gene in the soil, increase an amount of nxrA gene in the soil, decrease an amount of total suspended solids lost in run-off from the soil, decrease an amount of total dissolved solids lost in run-off from the soil, increase water holding capacity of the soil, and increase soil aggregation.

16. The method of claim 15 wherein the liquid composition comprises pasteurized Chlorella cells and Aurantiochytrium acetophilum HS399 cells in a ratio of 25:75.

17. The method of claim 15 wherein the Aurantiochytrium acetophilum HS399 cells have been subjected to an extraction process to remove oils from the Aurantiochytrium acetophilum HS399 cells.

18. The method of claim 15 wherein the liquid composition comprises between 1.2-24 g of at least one of pasteurized Chlorella cells and Aurantiochytrium acetophilum HS399 cells per gallon of carrier volume.

19. A method of improving health of soil comprising the steps of:
providing a liquid composition treatment comprising a culture of microalgae, the microalgae comprising at least one of pasteurized Chlorella cells and pasteurized Aurantiochytrium acetophilum HS399 cells;
diluting the liquid composition treatment to contain between 1.2-24 g of the at least one of pasteurized Chlorella cells and pasteurized Aurantiochytrium acetophilum HS399 cells per gallon of carrier volume; and
administering the liquid composition treatment to soil in the immediate vicinity of a plant, seedling, or seed in an effective amount to improve at least one soil characteristic.

20. The method of claim 19 wherein the soil characteristic is one of an amount of active carbon in the soil, an amount of protein in the soil, an amount of total suspended solids lost in run-off from the soil, an amount of total dissolved solids lost in run-off from the soil, an amount of healthy bacteria in the soil, an amount of nifH gene in the soil, an amount of nxrA gene in the soil, water holding capacity of the soil, and soil aggregation.
